(19) United States
(12) Patent Application Publication
(10) Pub. No.: US 2020/0001922 A1
(43) Pub. Date: Jan. 2, 2020

(54) TOW SUPPORT DEVICE

(71) Applicant: AISIN SEIKI KABUSHIKI KAISHA, Kariya-shi (JP)

(72) Inventors: Kinji YAMAMOTO, Anjo-shi (JP); Kazuya Watanabe, Anjo-shi (JP); Tetsuya Maruoka, Okazaki-shi (JP)

(73) Assignee: AISIN SEIKI KABUSHIKI KAISHA, Kariya-shi (JP)

(21) Appl. No.: 16/454,554

(22) Filed: Jun. 27, 2019

(30) Foreign Application Priority Data
Jun. 29, 2018 (JP) 2018-125310

(51) Int. Cl. B62D 15/02

(52) U.S. Cl. CPC B62D 15/029; B60W 30/18036; B62D 15/025

(57) ABSTRACT

A tow support device includes: an acquisition unit that acquires a connection angle between a tow vehicle and a towed vehicle; a setting unit that sets a target region to which at least the towed vehicle is movable; a course acquisition unit that acquires transition of a moving course of the towed vehicle based on a change in the connection angle in a case where the tow vehicle travels backward; and an output unit that outputs a first steering angle of the tow vehicle for maintaining the connection angle in a case where the moving course that transitions to correspond to backward traveling of the tow vehicle is a recommended moving course on which the towed vehicle is movable to the target region.

### CROSS REFERENCE TO RELATED APPLICATIONS

This application is based on and claims priority under 35 U.S.C. § 119 to Japanese Patent Application 2018-125310, filed on Jun. 29, 2018, the entire contents of which are incorporated herein by reference.

### TECHNICAL FIELD

An embodiment of this disclosure relates to a tow support device.

### BACKGROUND DISCUSSION

In the related art, a vehicle (tow vehicle) that tows a towed vehicle (trailer) is known. A tow device configured with a tow bracket and a coupling ball (hitch ball) is provided in a rear portion of the tow vehicle, and pivotably tows the towed vehicle. In a case where the tow vehicle travels forward in a state where the tow vehicle and the towed vehicle are connected to each other, the towed vehicle travels to follow a steering state of the tow vehicle in general. On the other hand, in a case where the tow vehicle travels backward, for example, for parking, that is, in a case where the towed vehicle is pushed by the tow vehicle, the towed vehicle shows different movement from the steering state of the tow vehicle. Depending on a connection angle between the tow vehicle and the towed vehicle of that time, for example, the towed vehicle is greatly bent at a portion of the tow device, or conversely, a bent angle becomes smaller in some cases. For this reason, in a case where the towed vehicle is intended to be moved, for example, to a parking region through backward traveling, highly sophisticated driving operation or experience is required. Thus, a system, which allows selecting the curvature of a moving course when the towed vehicle travels backward and performs steering control such that the towed vehicle moves backward in a state where the selected curvature is fixed, is proposed as a device that supports driving operation at the time of backward traveling of the towed vehicle.

An example of the related art includes U.S. Pat. No. 9,809,250.

However, in a case of the system of the related art, at which timing during backward traveling the curvature of the moving course of the towed vehicle is to be fixed still depends on driver's experience and intuition, and thus there is a problem that a burden to a driver is significant. In a case where the towed vehicle is traveled backward, it is meaningful enough if a tow support device that can smoothly move the towed vehicle to a desirable region (position) in a state where a burden to the driver is reduced can be provided.

### SUMMARY

A tow support device according to an embodiment of this disclosure includes an acquisition unit that acquires a connection angle between a tow vehicle and a towed vehicle, a setting unit that sets a target region to which at least the towed vehicle is movable, a course acquisition unit that acquires transition of a moving course of the towed vehicle based on a change in the connection angle in a case where the tow vehicle travels backward, and an output unit that outputs a first steering angle of the tow vehicle for maintaining the connection angle in a case where the moving course that transitions to correspond to backward traveling of the tow vehicle is a recommended moving course on which the towed vehicle is movable to the target region. In this configuration, for example, at a timing when the moving course of the towed vehicle, which travels backward while the connection angle is being changed, becomes the recommended moving course, the first steering angle at which the connection angle is maintained is output. As a result, the towed vehicle can be smoothly and easily traveled and moved to the target region regardless of skill of a driver.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view schematically illustrating an example of a connection state between a tow vehicle, on which a tow support device according to an embodiment is mounted, and a towed vehicle;

FIG. 2 is a top view schematically illustrating an example of the connection state between the tow vehicle, on which the tow support device according to the embodiment is mounted, and the towed vehicle;

FIG. 3 is an exemplary block diagram of a configuration of a tow support system including the tow support device according to the embodiment;

FIG. 4 is an exemplary block diagram of a configuration in a case where the tow support device according to the embodiment is realized by a CPU;

FIG. 5 illustrates an example of an image of a connecting member between the tow vehicle and the towed vehicle, which is captured by an imaging unit of the tow support system including the tow support device according to the embodiment, the image being captured when the towed vehicle is connected to the tow vehicle in a straightened state (serial state);

FIG. 6 illustrates an example of an image of the connecting member between the tow vehicle and the towed vehicle, which is captured by the imaging unit of the tow support system including the tow support device according to the embodiment, the image being captured when the towed vehicle is connected to the tow vehicle at a connection angle θ;

FIG. 7 is an exemplary schematic view illustrating a length of a wheel base of the towed vehicle in the tow support device according to the embodiment;

FIG. 8 is an exemplary schematic view illustrating an example of calculating the length of the wheel base of the towed vehicle in the tow support device according to the embodiment;

FIG. 9 is an exemplary schematic view illustrating a case where a first pivoting center position of the tow vehicle matches a second pivoting center position of the towed vehicle and thereby the tow vehicle and the towed vehicle are in a balanced state, in the tow support device according to the embodiment;

FIG. 10 is an exemplary schematic view illustrating a case where the first pivoting center position of the tow vehicle does not match the second pivoting center position of the towed vehicle and thereby the tow vehicle and the towed vehicle are in an imbalanced state, in the tow support device according to the embodiment;

FIG. 11 is an exemplary schematic view illustrating transition of a moving course of the towed vehicle in a case where the tow vehicle travels backward and a situation where the towed vehicle moves to a target region as the tow vehicle travels backward based on the first steering angle, in the tow support device according to the embodiment;

FIG. 12 is an exemplary schematic view illustrating a case where the towed vehicle has deviated from a recommended moving course in a case where the tow vehicle travels backward at the first steering angle to move the towed vehicle along the recommended moving course, in the tow support device according to the embodiment;

FIG. 13 is an exemplary schematic view illustrating estimation of a movement position of the towed vehicle in a case where the tow vehicle has traveled backward by a short distance in order to acquire a second steering angle in the tow support device according to the embodiment;

FIG. 14 is a partially enlarged view of FIG. 13;

FIG. 15 is an exemplary schematic view illustrating a situation where the tow vehicle is brought into the serial state with respect to the towed vehicle that has entered a target region in the tow support device according to the embodiment;

FIG. 16 is a flow chart showing an example of processing procedures in a case where the towed vehicle is moved to the target region in the tow support device according to the embodiment;

FIG. 17 is a flow chart showing an example of processing procedures in a case of bringing the towed vehicle and the tow vehicle into the serial state while minimizing a deflection angle of the towed vehicle moved to the target region in the tow support device according to the embodiment; and

FIG. 18 is a flow chart showing an example of processing procedures of simulation by means of a virtual steering angle for determining the second steering angle in FIG. 17.

### DETAILED DESCRIPTION

Hereinafter, an exemplary embodiment disclosed here will be disclosed. A configuration of the embodiment to be described below and action, a result, and an effect to be brought about by the configuration are merely examples. This disclosure can be realized by other configurations other than a configuration to be disclosed in the embodiment below, and can obtain at least one of various effects and derivative effects based on a basic configuration.

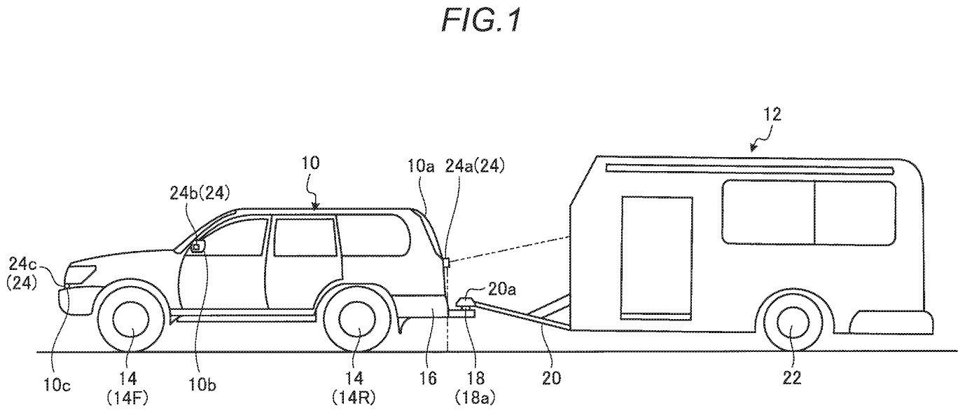

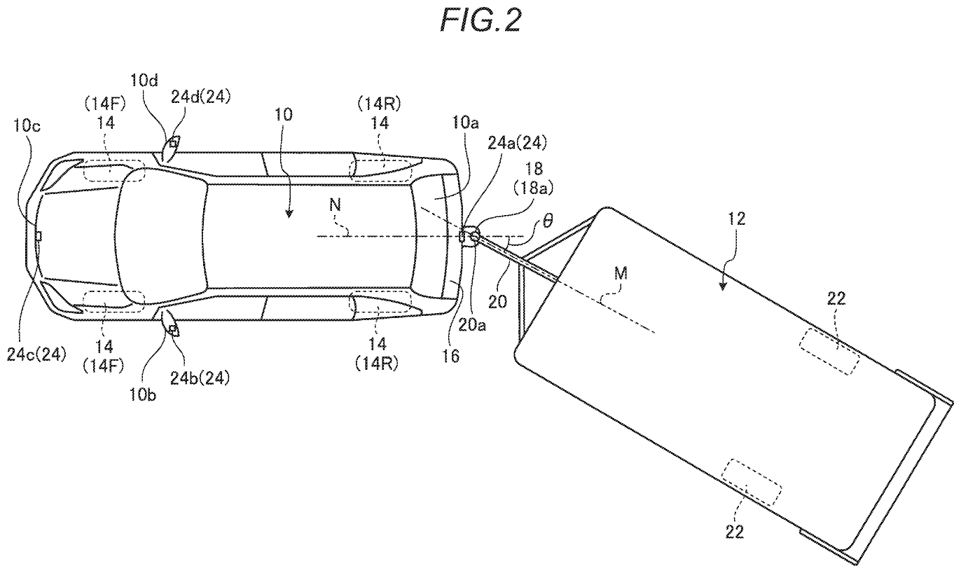

FIG. 1 is a side view illustrating a tow vehicle 10, in which a tow support device of the embodiment is mounted, and a towed vehicle 12 towed by the tow vehicle 10. In FIG. 1, a page left direction will be referred to as the front with the tow vehicle 10 as reference, and a page right direction will be referred to as the rear with the tow vehicle 10 as reference. FIG. 2 is a top view of the tow vehicle 10 and the towed vehicle 12 which are illustrated in FIG. 1.

For example, the tow vehicle 10 may be a car (internal combustion engine car) having an internal combustion engine (an engine, not illustrated) as a drive source, may be a car (an electric car, a fuel cell car, and the like) having an electric motor (a motor, not illustrated) as a drive source, or may be a car (hybrid car) having both of the internal combustion engine and the electric motor as drive sources. The tow vehicle 10 may be a sport utility vehicle (SUV) as illustrated in FIG. 1, or may be a so-called “pickup truck” in which a truck bed is provided on a rear side of the vehicle. In addition, the tow vehicle may be a general passenger car. Various transmissions can be mounted on the tow vehicle 10, or various devices (a system, a component, and the like) necessary for driving an internal combustion engine or an electric motor can be mounted on the tow vehicle. In addition, a method, a number, and a layout of a device related to driving of wheels 14 in the tow vehicle 10 can be variously set.

A tow device 18 (hitch) for towing the towed vehicle 12 protrudes, for example, from a lower middle portion of a rear bumper 16 of the tow vehicle 10 in a vehicle width direction. The tow device 18 is fixed to, for example, a frame of the tow vehicle 10. For example, the tow device 18 includes a hitch ball 18a having a spherical distal end portion provided to stand in a vertical direction (vehicle up-and-down direction), and a coupler 20a which is provided on a distal end portion of a connecting member 20 fixed to the towed vehicle 12 and covers the hitch ball 18a. As a result, the tow vehicle 10 and the towed vehicle 12 are connected to each other, and the towed vehicle 12 is swingable (pivotable) in the vehicle width direction with respect to the tow vehicle 10. That is, the hitch ball 18a transmits forward, backward, right and left movement to the towed vehicle 12 (connecting member 20), and receives power of acceleration or deceleration.

For example, the towed vehicle 12 may be a box type including at least one of a boarding space, a residential section, and a storage space as illustrated in FIG. 1, or may be a truck bed type on which a cargo (for example, a container and a boat) is loaded. For example, the towed vehicle 12 illustrated in FIG. 1 includes a pair of trailer wheels 22. The towed vehicle 12 of FIG. 1 is a driven vehicle including a coupled driving wheel that does not include a drive wheel and a steered wheel.

In addition, for example, four imaging units 24a to 24d are provided in the tow vehicle 10 as a plurality of imaging units 24 as illustrated in FIGS. 1 and 2. The imaging units 24 each are, for example, a digital camera in which an imaging element, such as a charge coupled device (CCD) and a CMOS image sensor (CIS), is built. The imaging units 24 can output moving image data (captured image data) at a predetermined frame rate. Each of the imaging units 24 has a wide-angle lens or a fisheye lens, and can image, for example, a range of 140° to 220° in a horizontal direction. In addition, optical axes of the imaging units 24 are set to face a diagonally downward direction in some cases. Therefore, the imaging units 24 each sequentially image a peripheral environment external to the tow vehicle 10, including a road surface where the tow vehicle 10 can move and an object (a pedestrian or a vehicle as an obstacle and a white line or a mark which is attached to a road surface), and output the image as captured image data.

The imaging unit 24a (rear imaging unit) is positioned, for example, on a lower wall portion of a rear hatch 10a which is on a rear side of the tow vehicle 10. The imaging unit 24a can image a region including a rear end portion (rear bumper 16) of the tow vehicle 10, the tow device 18, the connecting member 20, and at least a front end portion of the towed vehicle 12 (for example, an area indicated with a two-dot chain line, refer to FIG. 1) and a rear region of the towed vehicle 12, which is seen from the side of the towed vehicle 12. The captured image data obtained by the imaging unit 24a can be used in recognizing the towed vehicle 12 and detecting a connection state (for example, a connection angle, and connection or disconnection) between the tow vehicle 10 and the towed vehicle 12. In this case, since the connection state or the connection angle between the tow vehicle 10 and the towed vehicle 12 can be acquired based on the captured image data obtained by the imaging unit 24a, a system configuration can be simplified. In another embodiment, the connection angle may be acquired, for example, by a sensor provided on the periphery of the tow device 18 or on the tow device 18. In this case, processing for acquiring the connection angle can be simplified.

In addition, the imaging unit 24b (left imaging unit) is provided, for example, on a left end portion of the tow vehicle 10, for example, a left door mirror 10b, and captures a left image including a region (for example, a region from the front left to the rear left) having the left of the tow vehicle 10 as a center. The imaging unit 24c (front imaging unit) is provided, for example, on a front side of the tow vehicle 10, that is, a front end portion in a vehicle front-and-rear direction, for example, a front grille 10c or a front bumper, and captures a front image including the front of the tow vehicle 10. The imaging unit 24d (right imaging unit) is provided, for example, on a right end portion of the tow vehicle 10, for example, a right door mirror 10d, and captures a right image including a region (for example, a region from the front right to the rear right) having the right of the tow vehicle 10 as a center. Based on captured image data obtained by the plurality of imaging units 24, calculation processing or image processing is executed such that an image with a wider angle of view can be generated, or a virtual overhead image (planar image) seen from above the tow vehicle 10 can be generated.

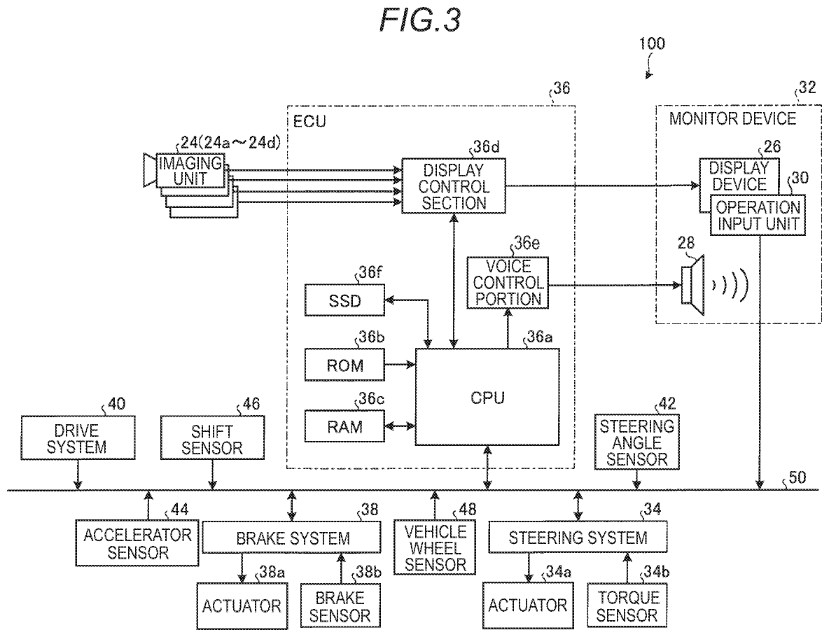

As shown in FIG. 3, a display device 26 and a voice output device 28 are provided in a passenger compartment of the tow vehicle 10. The display device 26 is, for example, a liquid crystal display (LCD) or an organic electroluminescent display (OELD). The voice output device 28 is, for example, a speaker. In addition, the display device 26 is covered with a transparent operation input unit 30, for example, a touch panel. A passenger (for example, a driver) can see an image displayed on a display screen of the display device 26 via the operation input unit 30. In addition, the passenger can execute operation input by operating, such as touching, pressing, and moving, the operation input unit 30 with a finger at a position corresponding to the image displayed on the display screen of the display device 26. The display device 26, the voice output device 28, the operation input unit 30 are provided, for example, in a monitor device 32 positioned in a middle portion of a dashboard of the tow vehicle 10 in the vehicle width direction, that is, a right-and-left direction. The monitor device 32 can have an operation input unit (not illustrated) such as a switch, a dial, a joystick, and a push-button. The monitor device 32 can serve as, for example, a navigation system and an audio system.

In addition, as illustrated in FIGS. 1 and 2, the tow vehicle 10 is, for example, a four-wheeled car, and has two right and left front vehicle wheels 14F and two right and left rear vehicle wheels 14R. All of the four wheels 14 can be configured to be steerable. As shown in FIG. 3, the tow vehicle 10 has a steering system 34 that steers at least the two wheels 14. The steering system 34 has an actuator 34a and a torque sensor 34b. The steering system 34 is electrically controlled by an electronic control unit 36 (ECU), and operates the actuator 34a. The steering system 34 is, for example, an electric power steering system or a steer by wire (SBW) system. The steering system 34 supplements steering power by applying torque, that is, assist torque to a steering wheel by means of the actuator 34a, or steers the wheels 14 by means of the actuator 34a. In this case, the actuator 34a may steer one wheel 14, or may steer the plurality of wheels 14. In addition, the torque sensor 34b detects, for example, torque applied to the steering wheel by a driver.

In addition to the ECU 36, the monitor device 32, the steering system 34, a brake system 38, a drive system 40, a steering angle sensor 42, an accelerator sensor 44, a shift sensor 46, and a vehicle wheel sensor 48 are electrically connected to each other via an in-vehicle network 50, which is an electric telecommunication line, in a tow support system 100 (tow support device) as shown in FIG. 3. The in-vehicle network 50 is configured as, for example, a controller area network (CAN). By transmitting a control signal through the in-vehicle network 50, the ECU 36 can control the steering system 34, the brake system 38, and the drive system 40. In addition, the ECU 36 can receive detection results of the torque sensor 34b, a brake sensor 38b, the steering angle sensor 42, the accelerator sensor 44, the shift sensor 46, and the vehicle wheel sensor 48, and an operation signal of the operation input unit 30 via the in-vehicle network 50.

The ECU 36 has, for example, a central processing unit 36a (CPU), a read only memory 36b (ROM), a random access memory 36c (RAM), a display control section 36d, a voice control portion 36e, and a solid state drive 36f (SSD or a flash memory). The CPU 36a reads a program stored (installed) in a nonvolatile storage device such as the ROM 36b, and executes calculation processing in accordance with the program. For example, in a case where the tow vehicle 10 to which the towed vehicle 12 is connected travels backward toward a target region (for example, a parking target region), the CPU 36a can acquire an appropriate steering angle for moving the towed vehicle 12 to the target region, or can support traveling of the tow vehicle 10 based on the steering angle. In addition, the CPU 36a executes, for example, calculation processing or image processing onto the captured image data obtained by the imaging units 24, and can generate a peripheral image (for example, an overhead image) showing a surrounding situation of the tow vehicle 10.

The RAM 36c temporarily stores various types of data used in calculation by the CPU 36a. The display control section 36d mainly executes composition of image data displayed by the display device 26, out of various types of calculation processing by the ECU 36. The voice control portion 36e mainly executes voice data output by the voice output device 28 out of various types of calculation processing by the ECU 36. The SSD 36f is a rewriteable nonvolatile storage unit, and can store data even in a case where a power supply of the ECU 36 is off. The CPU 36a, the ROM 36b, and the RAM 36c can be accumulated in the same package. Instead of the CPU 36a, the ECU 36 may have a configuration where another logic calculation processor, such as a digital signal processor (DSP), or another logic circuit is used. In addition, a hard disk drive (HDD) may be provided instead of the SSD 36f, or the SSD 36f and the HDD may be provided separately from the ECU 36.

The brake system 38 is, for example, an anti-lock brake system (ABS) that suppresses locking of a brake, a skidding prevention device (electronic stability control or ESC) that suppresses skidding of the tow vehicle 10 at the time of cornering, an electric brake system that enhances a braking force (executes brake assistance), or a brake by wire (BBW). The brake system 38 applies a braking force to the wheels 14 and the tow vehicle 10 via an actuator 38a. In addition, the brake system 38 can detect locking of a brake, idling of the wheels 14, and signs of skidding from a rotation difference between the right and left wheels 14 that can be acquired from the vehicle wheel sensor 48, and can execute various types of control. The brake sensor 38b is, for example, a sensor that detects a position of a movable unit of a brake pedal.

The drive system 40 is an internal combustion engine (engine) system or a motor system, which is a drive source. The drive system 40 controls a fuel jetting amount and an intake amount of an engine and controls an output value of a motor in accordance with a driver (user) requested operation amount detected by the accelerator sensor 44 (for example, an accelerator pedal pressed amount). In addition, regardless of operation of the driver, the drive system 40 can control output values of the engine and the motor in cooperation with control by the steering system 34 and the brake system 38 according to a traveling state of the tow vehicle 10.

The steering angle sensor 42 is, for example, a sensor that detects a steering amount of the steering wheel. The ECU 36 acquires a steering amount of the steering wheel by a driver and a steering amount (steering angle) of each of the wheels 14 at the time of automatic steering from the steering angle sensor 42 to execute various types of control. The accelerator sensor 44 is, for example, a sensor that detects a position of a movable unit of the accelerator pedal. The shift sensor 46 is, for example, a sensor that detects a position of a movable unit of a shift operation unit. The vehicle wheel sensor 48 is a sensor that detects a rotation amount or the number of times of rotation per unit time of each of the wheels 14. The vehicle wheel sensor 48 outputs the number of wheel speed pulses indicating the detected number of times of rotation as a sensor value. The ECU 36 calculates a moved amount of the tow vehicle 10 based on the sensor value acquired from the vehicle wheel sensor 48, and executes various types of control.

A configuration, disposition, an electrical connection form of various types of sensors and actuators described above are merely examples, and can be variously set (changed).

The tow support system 100 can execute mainly three types of processing by various types of processing performed by a tow support unit realized by the CPU 36a. Firstly, the tow support system 100 executes control for traveling the tow vehicle 10, to which the towed vehicle 12 is connected, backward and moving the towed vehicle 12 such that the towed vehicle is smoothly and easily accommodated in the target region. Secondly, the tow support system 100 executes, with respect to the towed vehicle 12 moved to (accommodated in) the target region, control for bringing the tow vehicle 10 into a serial state (straightened state) with respect to the towed vehicle 12 while suppressing a change (deflection) in a posture of the towed vehicle 12 that is in the target region to the minimum. Thirdly, the tow support system 100 executes control for moving the tow vehicle and the towed vehicle such that each vehicle is accommodated in the target region while maintaining the connection angle between the towed vehicle 12 and the tow vehicle 10 which are in the serial state.

However, in a case where the tow vehicle 10 to which the towed vehicle 12 is connected travels forward, or in a case the tow vehicle travels backward (traveling while pushing the towed vehicle 12 back), a state where the connection angle between the tow vehicle 10 and the towed vehicle 12 is practically maintained is caused in some cases. Such a connection state will be referred to as a “balanced state”. In addition, the connection angle at that time will be referred to as a “balance angle”. In a case of the balanced state, the movement of the tow vehicle 10 mostly matches the movement of the towed vehicle 12, for example, at the time of backward traveling. On the contrary, in a case of an “imbalanced state”, a connection angle of the towed vehicle 12 changes every second as the tow vehicle 10 travels backward. Switching between the “balanced state” and the “imbalanced state” can be executed by adjusting the steering angle of the tow vehicle 10 and changing a pivoting radius of the tow vehicle 10. Therefore, it becomes possible to control a backward traveling course of the towed vehicle 12 by intentionally switching between the “balanced state” and the “imbalanced state”.

In order to move the towed vehicle 12 to the target region as described above, the tow support system 100 acquires an appropriate steering angle of the tow vehicle 10, and executes backward traveling at the steering angle at an appropriate timing. As a result, regardless of skill of a driver (such as driving ability), the tow support system 100 can execute processing of smoothly and reliably moving the towed vehicle 12 and the tow vehicle 10 to the target region while reducing the burden of operation.

In the description below, a case of parking the towed vehicle 12 or the towed vehicle 12 and the tow vehicle 10 in a predetermined parking target region (parking space) will be described as an example of support in a case of moving the tow vehicle 10 to which the towed vehicle 12 is connected to the target region.

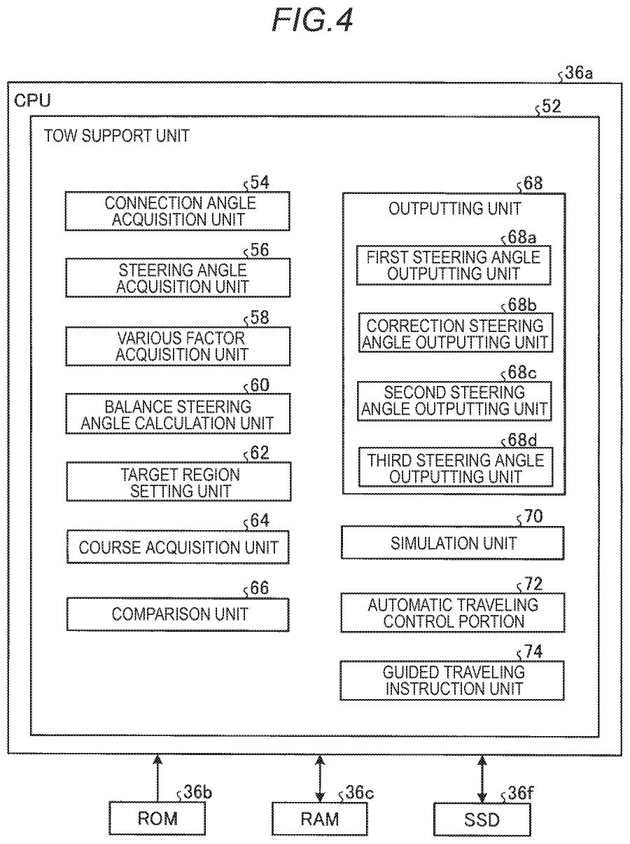

FIG. 4 is an exemplary block diagram of a tow support unit 52 realized by the CPU 36a in the tow support system 100 in order to execute mainly the three types of tow support as described above.

The tow support unit 52 is realized by the CPU 36a reading a program which is installed and stored in a storage device such as the ROM 36b, and executing the processing. The tow support unit 52 includes various types of modules for realizing each type of processing described above. For example, the tow support unit 52 includes modules such as a connection angle acquisition unit 54 (acquisition unit), a steering angle acquisition unit 56, a various factor acquisition unit 58, a balance steering angle calculation unit 60, a target region setting unit 62 (setting unit), a course acquisition unit 64, a comparison unit 66, an outputting unit 68, a simulation unit 70, an automatic traveling control portion 72, and a guided traveling instruction unit 74. In addition, the outputting unit 68 includes a first steering angle outputting unit 68a, a correction steering angle outputting unit 68b, a second steering angle outputting unit 68c, and a third steering angle outputting unit 68d.

The connection angle acquisition unit 54 acquires the connection angle between the tow vehicle 10 and the towed vehicle 12. The steering angle acquisition unit 56 acquires the current steering angle of the tow vehicle 10. The various factor acquisition unit 58 mainly acquires various factor data of the towed vehicle 12. The balance steering angle calculation unit 60 executes calculation related to a balance angle between the tow vehicle 10 and the towed vehicle 12. The target region setting unit 62 sets a target region to which the towed vehicle 12 or the tow vehicle 10 can be moved. The course acquisition unit 64 acquires transition of a moving course that changes in a case where the towed vehicle 12 travels backward. The comparison unit 66 performs comparison of target values related to a movement position, a moving course, and a vehicle posture in order to improve the accuracy of moving the towed vehicle 12 or the tow vehicle 10 to the target region. The outputting unit 68 outputs various steering angles provided to the tow vehicle 10 in order to mainly execute tow support. The simulation unit 70 executes simulation for acquiring an optimal steering angle mainly when making the connection state of the tow vehicle 10 with respect to the towed vehicle 12 straight (serial state). The automatic traveling control portion 72 realizes automatic traveling of the tow vehicle 10 when executing tow support. The guided traveling instruction unit 74 gives a guided traveling instruction for a driver to drive (manually drive) the tow vehicle 10 when executing tow support.

Hereinafter, details of each module will be described.

The connection angle acquisition unit 54 acquires the connection angle between the tow vehicle 10 and the towed vehicle 12, for example, an angle of the connecting member 20 having the tow device 18 as a fulcrum. The connection angle can be acquired through various methods. For example, an image based on the captured image data obtained by the imaging unit 24a can be acquired through image processing.

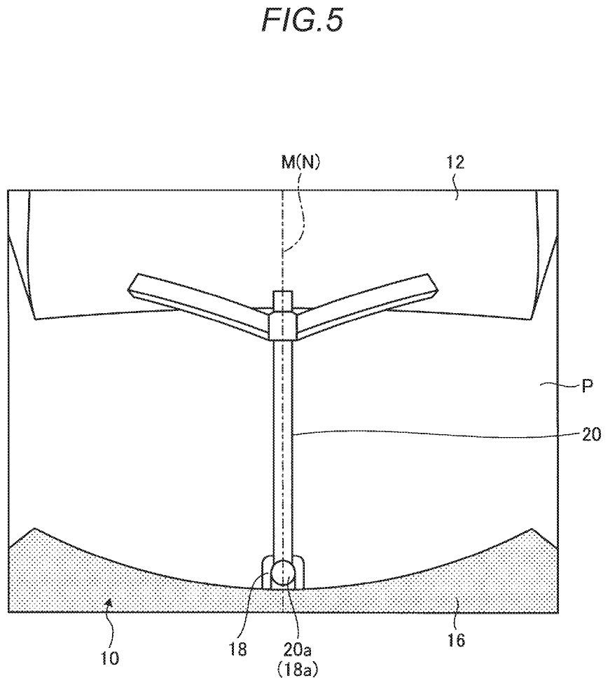

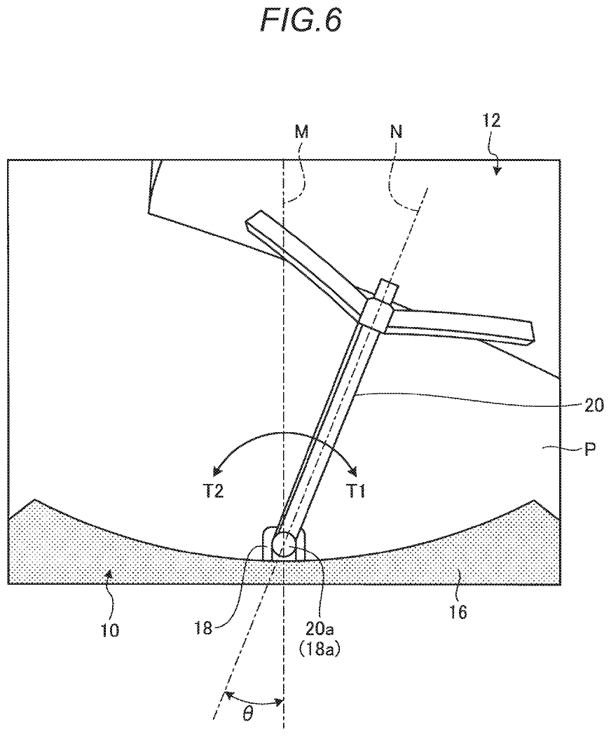

FIGS. 5 and 6 each are an example of an image P based on the captured image data obtained by the imaging unit 24a. The rear bumper 16 of the tow vehicle 10, the tow device 18, and a part of a tip of the towed vehicle 12 are included in the image P. FIG. 5 is a view illustrating a so-called “serial state” where the towed vehicle 12 is connected to the tow vehicle 10 straight (connection angle θ=“0”). The tow device 18 is positioned, for example, almost in the middle of the tow vehicle 10 in the vehicle width direction. That is, a connection central axis N which extends in a front-and-rear direction (longitudinal direction) of the connecting member 20 and passes through the coupler 20a is in a state of practically overlapping a vehicle central axis M which extends in a front-and-rear direction of the tow vehicle 10 and passes through the hitch ball 18a. FIG. 6 illustrates a state where the connecting member 20 (towed vehicle 12) pivots (is bent and towed), for example, in an arrow T1 direction with the tow device 18 of the tow vehicle 10 as a fulcrum, and has the connection angle θ. In this case, the towed vehicle 12 pivots (is bent) to the left when seen from a driver's seat of the tow vehicle 10.

The connection angle acquisition unit 54 detects a straight line passing through the hitch ball 18a of the tow device 18 from the image P based on the captured image data obtained by the imaging unit 24a, and sets the straight line as the connection central axis N of the connecting member 20. Since the vehicle central axis M of the tow vehicle 10 on the image P captured by the imaging unit 24a is known, the connection angle θ can be detected from the vehicle central axis M and the connection central axis N. Also a connection angle in a case where the towed vehicle 12 (connecting member 20) pivots (is bent) in an arrow T2 direction can be detected similarly. In a case of the embodiment, an example in which the imaging unit 24a is disposed immediately above the tow device 18, that is, coaxially with the vehicle central axis M is given. That is, since the connecting member 20 can be viewed from almost right above, it is easy to detect the connection angle θ formed by the vehicle central axis M and the connection central axis N. On the other hand, the imaging unit 24a cannot be provided immediately above the tow device 18 in some cases due to structural conditions of the tow vehicle 10 and other reasons. For example, in some cases, the imaging unit 24a is provided at a position shifted away from the middle of the rear hatch 10a in any direction of the right and the left. In this case, the connection angle θ can be detected based on the vehicle central axis M and the connection central axis N by converting two-dimensional coordinates of the image P captured by the imaging unit 24a into three-dimensional coordinates based on a ground height (a known value based on a specification) of the tow device 18 (hitch ball 18a).

In another embodiment, a direction of the towed vehicle 12 with respect to the tow vehicle 10, that is, the connection angle θ may be calculated by assigning a mark, which is easy to identify, to a front end surface of the towed vehicle 12 and identifying a position of the mark on the image P. In this case, by disposing a plurality of marks, for example, at right and left positions on the front end surface, improvement of identification accuracy can be achieved. In another embodiment, for example, an angle sensor may be provided in the tow device 18 or on the periphery thereof to detect an angle of the connecting member 20 with respect to the tow device 18, and the angle may be the connection angle θ. In this case, a processing load of a CPU 40a can be reduced.

The steering angle acquisition unit 56 acquires a steering angle of the tow vehicle 10 detected by the steering angle sensor 42. That is, the steering angle acquisition unit acquires a steering angle in a direction where a driver intends to travel the tow vehicle 10 after this. The steering angle acquisition unit 56 may be set to acquire information on whether the tow vehicle 10 is in a forward movement possible state or a backward movement possible state based on a position of a movable unit of a transmission operation unit, which is output by the shift sensor 46, such that whether the current steering angle is a steering angle at the time of a forward movement state or a steering angle at the time of a backward movement state can be identified.

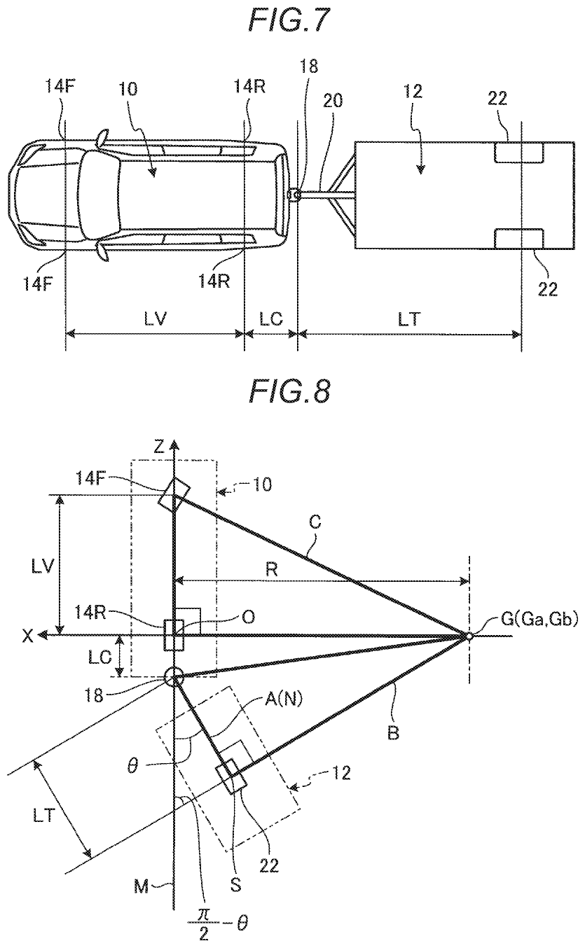

The various factor acquisition unit 58 mainly acquires various factors of the towed vehicle 12. Whether or not the tow vehicle 10 and the towed vehicle 12 described above are in the balanced state can be determined, for example, by whether or not a pivoting center position of the tow vehicle 10 (first pivoting center position) matches a pivoting center position of the towed vehicle 12 (second pivoting center position). For example, in a case where the first pivoting center position matches the second pivoting center position, the balanced state is caused. The first pivoting center position of the tow vehicle 10 can be acquired based on the current steering angle of the tow vehicle 10 and a length LV of a wheel base of the tow vehicle 10 (refer to FIG. 7). The second pivoting center position of the towed vehicle 12 can be acquired based on the connection angle 0 between the tow vehicle 10 and the towed vehicle 12 and a length LT of a wheel base of the towed vehicle 12 (refer to FIG. 7). The length LT of the wheel base of the towed vehicle 12 is a length from the tow device 18 to an axle of the trailer wheels 22 of the towed vehicle 12 including the connecting member 20. However, the towed vehicle 12 having various specifications can be connected to the tow vehicle 10, and the length LT of the wheel base differs according to the specification of the towed vehicle 12. The various factor acquisition unit 58 may acquire the length LT of the wheel base of the towed vehicle 12 which is connected through direct input by a driver using the operation input unit 30 of the monitor device 32, or may acquire a value estimated by the tow vehicle 10 towing the towed vehicle 12 and traveling forward, which is considered as the length LT of the wheel base. In a case where the driver directly inputs, for example, the input can be performed with reference to the specification of the towed vehicle 12.

FIG. 8 is a schematic view illustrating an example of a method of estimating the length LT of the wheel base of the towed vehicle 12. In order to simplify description, in a case of FIG. 8, description will be made with the use of a two-wheel shaft model in which all of the front vehicle wheels 14F and the rear vehicle wheels 14R of the tow vehicle 10 and the trailer wheels 22 of the towed vehicle 12 exist in the middle in the vehicle width direction, that is, on a central axis extending in the vehicle front-and-rear direction (the front vehicle wheels 14F and the rear vehicle wheels 14R are on the vehicle central axis M, and the trailer wheels 22 are on the connection central axis N).

As described above, whether or not the tow vehicle 10 and the towed vehicle 12 are in the balanced state is determined with the use of the pivoting center positions of the tow vehicle 10 and the towed vehicle 12 which are to be calculated, based on the connection angle θ between the tow vehicle 10 and the towed vehicle 12, the steering angle of the tow vehicle 10, the length LV of the wheel base of the tow vehicle 10, and the length LT of the wheel base of the towed vehicle 12. In other words, in a case where the tow vehicle 10 and the towed vehicle 12 are in the balanced state at the connection angle θ, the length LT of the wheel base of the towed vehicle 12 can be calculated back based on this state. In a case where the tow vehicle 10 travels the towed vehicle 12 forward at a constant pivoting radius (in a case of followed towing), a connection posture between the tow vehicle 10 and the towed vehicle 12 which are in the balanced state at the connection angle θ can be easily formed.

FIG. 8 is a view illustrating a case where the tow vehicle 10 travels forward (forward towing) at a pivoting radius R with a pivoting center position G as a center on an X-Z coordinate system. In the case of FIG. 8, the rear vehicle wheels 14R of the tow vehicle 10 are set to exist at a position of the origin O on the X-Z coordinate system, and the front vehicle wheels 14F of the tow vehicle 10 are steered at an angle with which the rear vehicle wheels 14R can pivot at the pivoting radius R. As described above, when the tow vehicle 10 continues forward traveling (pivot traveling) while maintaining a constant steering angle, the towed vehicle 12 follows and travels with the pivoting center position G (Ga, Gb) as a center, just as the tow vehicle 10, in a state where the connection angle θ with respect to the vehicle central axis M of the tow vehicle 10 is maintained with the tow device 18 fixed to the tow vehicle 10 as a fulcrum. At this time, the length LV of the wheel base of the tow vehicle 10 and a hitch distance LC from a position of an axle of the rear vehicle wheels 14R to the tow device 18 are known based on a specification of the tow vehicle 10, and the pivoting radius R can be calculated based on a detection result of the steering angle sensor 42 of the tow vehicle 10. In addition, the connection angle θ can be acquired based on captured image data obtained by the imaging unit 24a of the tow vehicle 10. In a case where the towed vehicle 12 pivots in the balanced state around the pivoting center position G, the axle of the trailer wheels 22 of the towed vehicle 12 exists at a position where a straight line passing through the pivoting center position G and the connection central axis N are orthogonal to each other. Therefore, first, information indicating a straight line A, which passes through the tow device 18 and has an inclination of the connection angle θ (for example, an equation of the straight line A), in FIG. 8 is acquired. In addition, the pivoting center position G (coordinates) can be acquired from the steering angle of the tow vehicle 10 and the length LV of the wheel base. Information indicating a straight line B, which passes through the pivoting center position G and has an inclination of (π/2)−θ (for example, an equation of the straight line B), can be acquired, and information (coordinates) of an intersection point S between the straight line A and the straight line B can be acquired. The length LT of the wheel base of the towed vehicle 12 can be estimated from coordinates of the tow device 18 and the coordinates of the intersection point S.

In a case where the tow vehicle 10 to which the towed vehicle 12 is connected is traveled backward, the balance steering angle calculation unit 60 calculates the steering angle of the tow vehicle 10 (balance steering angle), at which the “balanced state” where the connection state between the tow vehicle 10 and the towed vehicle 12 is maintained is caused. In addition, the balance steering angle calculation unit 60 intentionally pivots the towed vehicle 12 with respect to the tow vehicle 10 at the time of backward traveling of the tow vehicle 10 without bringing into the “balanced state”, and calculates a steering angle (imbalance steering angle) in a case of adjusting a connection posture (connection angle) of the tow vehicle 10 with respect to the towed vehicle 12 by intentionally pivoting the tow vehicle 10 with respect to the towed vehicle 12 at a steering angle at which an orientation of the towed vehicle 12 faces a desirable direction.

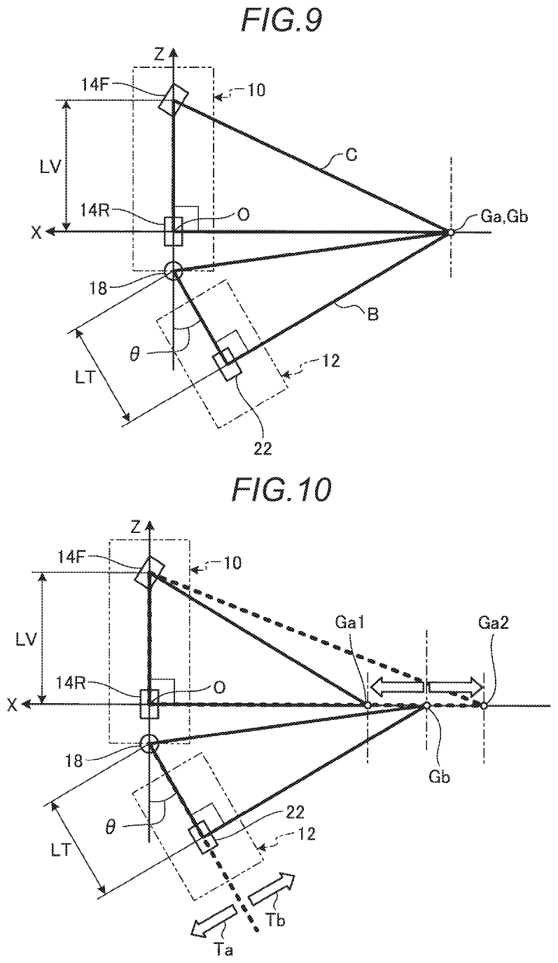

FIGS. 9 and 10 are exemplary schematic views illustrating a relationship between a first pivoting center position Ga of the tow vehicle 10 and a second pivoting center position Gb of the towed vehicle 12. FIG. 9 illustrates a case where the first pivoting center position Ga matches the second pivoting center position Gb and thus the “balanced state” is caused, and FIG. 10 illustrates a case where the first pivoting center position Ga does not match the second pivoting center position Gb and thus the “imbalanced state” is caused.

As illustrated in FIG. 9, for example, in a case where it is assumed that the rear vehicle wheels 14R of the tow vehicle 10 exist at the origin O on X-Z coordinate system, positions of the front vehicle wheels 14F on a Z-axis are determined if the length LV of the wheel base of the tow vehicle 10 is known. An intersection point between an extended line (straight line C) of an axle of the front vehicle wheels 14F at the current steering angle and an X-axis becomes the first pivoting center position Ga of the tow vehicle 10. That is, in a case where the tow vehicle 10 travels at the current steering angle, the first pivoting center position Ga of the tow vehicle 10 can be acquired based on the steering angle of the tow vehicle 10 and the length LV of the wheel base. In a case of the towed vehicle 12, positions of the trailer wheels 22 of the towed vehicle 12 are determined on the X-Z coordinate system if a position of the tow device 18, the connection angle θ, and the length LT of the wheel base of the towed vehicle 12 are known. The second pivoting center position of the towed vehicle 12 exists on an extended line (straight line B) of the axle of the trailer wheels 22, and an intersection point of the extended line with the X-axis becomes the second pivoting center position Gb of the towed vehicle 12. The balance steering angle calculation unit 60 acquires a “balance steering angle” at a certain timing by calculating the second pivoting center position Gb of the towed vehicle 12 and calculating the steering angle of the tow vehicle 10, at which the first pivoting center position Ga of the tow vehicle 10 matches the calculated second pivoting center position Gb of the towed vehicle 12.

On the other hand, the balance steering angle calculation unit 60 can calculate an “imbalance steering angle”. As illustrated in FIG. 10, in a case where the first pivoting center position Ga of the tow vehicle 10 and the second pivoting center position Gb of the towed vehicle 12 are different from each other, the tow vehicle 10 and the towed vehicle 12 which are connected to each other by the tow device 18 are in the imbalanced state. As described above, the second pivoting center position Gb of the towed vehicle 12 is determined by the connection angle θ and the length LT of the wheel base. On the other hand, the tow vehicle 10 can freely change a steering angle thereof by the steering of a steering unit. That is, the first pivoting center position Ga can be accurately adjusted regardless of the connection angle θ. For example, in a case where the steering angle of the tow vehicle 10 is further rotated to the right (clockwise direction) from the state of FIG. 9, the tow vehicle 10 pivots at a pivoting radius smaller than in the case of FIG. 9. That is, the pivoting center position of the tow vehicle 10 is moved on the X-axis of FIG. 10 to the left in FIG. 10 and becomes, for example, a first pivoting center position Ga1. On the contrary, in a case where the steering angle of the tow vehicle 10 is further rotated to the left (counterclockwise direction) from the state of FIG. 9, the tow vehicle 10 pivots at a pivoting radius larger than in the case of FIG. 9. That is, the pivoting center position of the tow vehicle 10 is moved on the X-axis of FIG. 10 to the right in FIG. 10 and becomes, for example, a first pivoting center position Ga2. In a case where the tow vehicle 10 is moved backward such that the tow vehicle pivots around the first pivoting center position Ga1, the towed vehicle 12 moves backward while changing a connection posture in a direction Ta where the current connection angle θ becomes smaller. In addition, in a case where the tow vehicle 10 is moved backward such that the tow vehicle pivots around the first pivoting center position Ga2, the towed vehicle 12 moves backward while changing a connection posture in a direction Tb where the current connection angle θ becomes larger. Therefore, the balance steering angle calculation unit 60 can calculate the steering angle of the tow vehicle 10 at which a direction where the towed vehicle 12 pivots is adjusted, that is, the “imbalance steering angle” at a certain timing by calculating the second pivoting center position Gb of the towed vehicle 12.

The target region setting unit 62 sets a target region (for example, a parking target position) to which at least the towed vehicle 12 can be moved. For example, in a case where the tow vehicle 10 to which the towed vehicle 12 is connected travels forward, the target region setting unit 62 acquires captured images obtained by the imaging units 24. Then, the target region setting unit 62 executes known white line detection processing or known object recognition processing onto the acquired captured images, and detects a region where the towed vehicle 12 can be accommodated. At this time, the target region setting unit 62 searches the captured images for a region to which the towed vehicle 12 can move (park) based on various types of factor data of the towed vehicle 12, which are acquired by the various factor acquisition unit 58 (for example, a vehicle width of the towed vehicle 12 and the length LT of the wheel base), and shows the region, for example, onto the display device 26. In this case, the target region setting unit 62 may detect a plurality of regions to which the towed vehicle 12 can move (park) (for example, a frame and a parking frame), and may cause a driver to select any one of the plurality of regions displayed on the display device 26 as candidates of a target region. In another embodiment, the target region setting unit 62 may cause the display device 26 to display, for example, a recommended target region where a moving (parking) operation can be completed with the easiest steering and the shortest moving distance, out of the plurality of candidates. In addition, the target region setting unit 62 may cause the driver to designate a desirable position on a peripheral image displayed on the display device 26, and the position may be set as a target region.

The course acquisition unit 64 acquires transition of a moving course of the towed vehicle 12 based on a change in the connection angle in a case where the tow vehicle 10 travels backward. As described above, the connection angle of the towed vehicle 12 which is in the imbalanced state with respect to the tow vehicle 10 changes every second due to backward traveling of the tow vehicle 10, thereby changing the orientation of the towed vehicle 12. As described above, the second pivoting center position of the towed vehicle 12 can be calculated based on the position of the tow device 18, the connection angle θ, and the length LT of the wheel base. That is, the course acquisition unit 64 can acquire a moving course with the current position of the towed vehicle 12 as reference and transition thereof by acquiring a pivoting radius of the towed vehicle 12 associated with a change in the connection angle.

The comparison unit 66 compares a position of the target region set by the target region setting unit 62 with a transitional position of the moving course of the towed vehicle 12 acquired by the course acquisition unit 64, and can set, when a transitioning moving path reaches a timing at which the towed vehicle 12 can be moved to (can be accommodated in) the target region, the moving course as a recommended moving course. For example, an opening of the target region set by the target region setting unit 62 (a width of an entrance of the towed vehicle 12) can be estimated based on the captured images obtained by the imaging units 24, and thus a middle position of the opening (a middle point of the width of the entrance of the target region) can be recognized. Therefore, in a case where the transitioning moving course has entered a predetermined area in the opening direction with respect to the middle position of the opening, the comparison unit 66 sets the moving path as a recommended moving course.

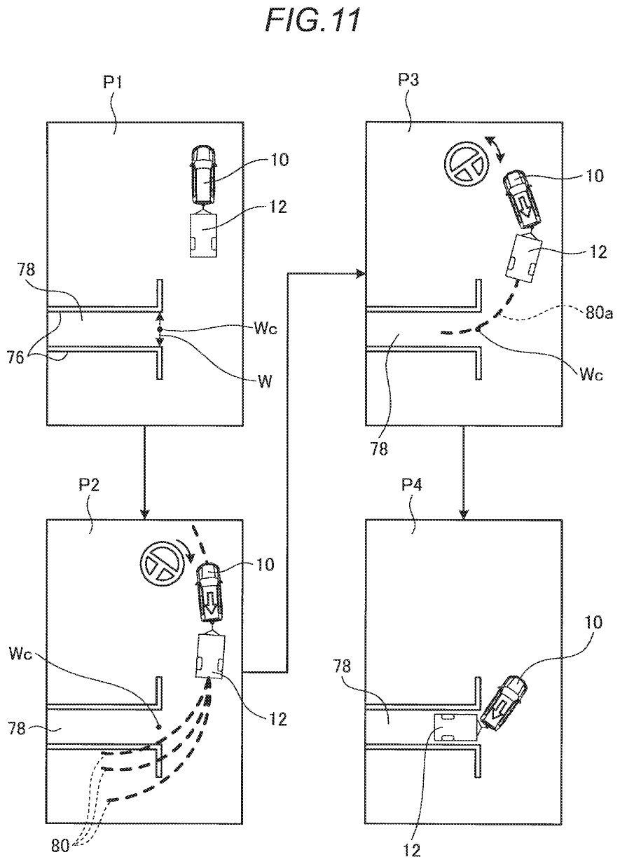

FIG. 11 is an exemplary schematic view illustrating a situation of acquiring a recommended moving course and a situation of moving the towed vehicle 12, which are performed by the target region setting unit 62, the course acquisition unit 64, and the comparison unit 66.

First, the imaging units 24 image a surrounding situation of the tow vehicle 10 while the tow vehicle 10 to which the towed vehicle 12 is connected travels forward as illustrated in a scene P1 of FIG. 11. The target region setting unit 62 sets, for example, a target region 78, which is assumed as a white line 76 and to which the towed vehicle 12 is moved (parked), based on the captured images. In this case, a captured image obtained by any imaging unit 24 out of the imaging units 24a to 24d may be used. In a case where the target region 78 is set, the comparison unit 66 sets a middle position Wc of an opening W. In a case of the scene P1, since the target region 78 exists on the left with respect to the tow vehicle 10, the pivoting center position of the tow vehicle 10 needs to be moved to the first pivoting center position Ga1 as illustrated in FIG. 10 in order for the towed vehicle 12 to become closer to the target region 78 while traveling backward. That is, it is necessary to steer the steering wheel of the tow vehicle 10 to the right as illustrated in a scene P2.

When the tow vehicle 10 is traveled backward in a state of being steered to the right, the towed vehicle 12 moves while changing an orientation thereof to the left as illustrated in the scene P2. In this case, the connection angle between the tow vehicle 10 and the towed vehicle 12 changes every second as the tow vehicle 10 travels backward, and thus a moving course 80 transitions. The comparison unit 66 compares the middle position Wc of the opening W of the target region 78 set in advance with the transitioning moving course 80. In a case where the transitioning moving course 80 has entered a predetermined area in the opening direction with respect to the middle position Wc, the comparison unit sets the moving course 80 as a recommended moving course 80a (refer to the scene P3). In a case where the tow vehicle 10 and the towed vehicle 12 travel backward in accordance with the recommended moving course 80a without causing a change in the connection angle as illustrated in the scene P3, the towed vehicle 12 can move to the target region 78 as illustrated in a scene P4. Therefore, when the recommended moving course 80a is acquired by the comparison unit 66, the balance steering angle calculation unit 60 calculates a balance steering angle of the tow vehicle 10 based on the current connection angle of the towed vehicle 12.

Referring back to FIG. 4, the outputting unit 68 outputs, as appropriate, the steering angle of the tow vehicle 10 for appropriately moving the towed vehicle 12 while executing tow support processing of the towed vehicle 12. For example, in a case where the recommended moving course 80a is acquired in cooperation with the course acquisition unit 64 and the comparison unit 66 in the scene P3 of FIG. 11, the first steering angle outputting unit 68a acquires a first steering angle of the tow vehicle 10 for maintaining the connection angle (first steering angle) from the balance steering angle calculation unit 60 and outputs the first steering angle.

In a case where tow support is executed by the automatic traveling control portion 72 performing automatic traveling control, the first steering angle outputting unit 68a outputs the first steering angle to the automatic traveling control portion 72. In addition, in a case where tow support is executed in accordance with a guided traveling instruction given by the guided traveling instruction unit 74, the first steering angle outputting unit 68a outputs the first steering angle to the guided traveling instruction unit 74. A mode in which the first steering angle outputting unit 68a outputs the first steering angle is referred to as a “connection angle maintaining mode” in some cases.

In a case where backward traveling for tow support starts, the tow support system 100 may cause the balance steering angle calculation unit 60 to calculate the steering angle of the tow vehicle 10 for changing the connection angle such that the towed vehicle 12 is inclined to (sees) a direction where the target region 78 exits, and to output the steering angle to the automatic traveling control portion 72 or the guided traveling instruction unit 74 via the outputting unit 68. In this case, the balance steering angle calculation unit 60 calculates the steering angle of the tow vehicle 10 for causing the towed vehicle 12 to face the target region 78, for example, based on the current connection angle acquired by the connection angle acquisition unit 54, the current steering angle of the tow vehicle 10 acquired by the steering angle acquisition unit 56, and a vehicle speed of the tow vehicle 10 that can be acquired from the vehicle wheel sensor 48. In this case, the balance steering angle calculation unit 60 outputs the “imbalance steering angle” or a combination of the “imbalance steering angle” and the “balance steering angle”, and calculates a steering angle at which the moving course of the towed vehicle 12 becomes practically the same as the recommended moving course efficiently and smoothly. Then, the outputting unit 68 outputs the calculated steering angle to the automatic traveling control portion 72 or the guided traveling instruction unit 74, and the towed vehicle 12 is moved through automatic traveling or manual traveling. As a result, the tow support system 100 can smoothly and efficiently realize a series of moving operations for moving the towed vehicle 12 to the target region 78 from the start of backward traveling of the tow vehicle 10.

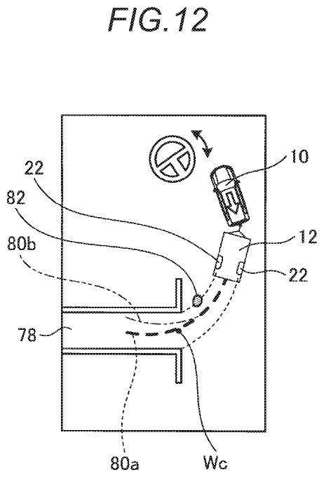

However, in a case where the towed vehicle 12 and the tow vehicle 10 actually move in accordance with the recommended moving course 80a, an actual course 80b in which the towed vehicle 12 actually moves is shifted away from the recommended moving course 80a in some cases as illustrated in FIG. 12 due to a road surface state and other external factors. For example, in a case where the trailer wheels 22 of the towed vehicle 12 have passed through the unevenness of the road surface or a stone 82, the orientation of the trailer wheels 22, that is, the orientation (connection angle) of the towed vehicle 12 changes in some cases. In this case, the balance steering angle calculation unit 60 calculates a correction steering angle of the tow vehicle 10 for bringing the actual course 80b of the towed vehicle 12 back to the recommended moving course 80a based on the changed connection angle. In this case, the balance steering angle calculation unit 60 calculates the correction steering angle of the tow vehicle 10 at which the moving course changes toward the middle position We of the opening W of the target region 78. That is, a direction where the towed vehicle 12 is shifted (the direction Ta or the direction Tb: refer to FIG. 10) is acquired according to a situation where the actual course 80b is shifted away from the recommended moving course 80a. The steering angle of the tow vehicle 10, at which the towed vehicle 12 is moved by an amount according to a shifted amount of the actual course 80b and thus the first pivoting center position of the tow vehicle 10 is realized, is calculated as a correction steering angle. The correction steering angle outputting unit 68b acquires the correction steering angle from the balance steering angle calculation unit 60 to output the correction steering angle to the automatic traveling control portion 72 or the guided traveling instruction unit 74, and thus the tow vehicle 10 travels backward such that the actual course 80b of the towed vehicle 12 is corrected. In a case where the comparison unit 66 has detected that the actual course 80b has been brought back to the recommended moving course 80a, the first steering angle outputting unit 68a again acquires the first steering angle at which the current connection angle is maintained from the balance steering angle calculation unit 60 and outputs the first steering angle.

The simulation unit 70 mainly executes simulation for acquiring an optimal steering angle when making the connection state of the tow vehicle 10 with respect to the towed vehicle 12 straight (serial state). As described above, at a timing when the first steering angle outputting unit 68a outputs the first steering angle, the towed vehicle 12 travels the tow vehicle 10 backward at the “balance steering angle”, which is an example of the first steering angle. As a result, for example, the towed vehicle 12 can move to the target region 78 as illustrated in the scene P4 of FIG. 11. In this case, the tow vehicle 10 is bent with respect to the towed vehicle 12 in some cases (connection angle is not “0°” in some cases) as in the scene P4. In a case where the tow vehicle 10 is separated away from the towed vehicle 12 and only the tow vehicle 10 moves to another place simply by moving (parking) the towed vehicle 12 to the target region 78, it is not necessary to consider the connection angle when the towed vehicle 12 has moved to the target region 78. On the other hand, in a case where the towed vehicle 12 and the tow vehicle 10 are intended to be moved (parked) to the target region 78, it is necessary to make the tow vehicle 10 straight (serial state) with respect to the towed vehicle 12 from the state of the scene P4 of FIG. 11. Thus, in a case where the towed vehicle 12 has moved to (accommodated in) the target region 78 (the state of the scene P4), the simulation unit 70 acquires, through simulation, a second steering angle of the tow vehicle 10 at which a deflection angle of the tow vehicle 10 is made close to a deflection angle of the towed vehicle 12 (second steering angle) in a case where the tow vehicle 10 is traveled backward after maintaining a posture of the towed vehicle 12 with respect to the target region 78 (a deflection angle to be described later). In other words, the simulation unit 70 calculates the deflection angle of the towed vehicle 12 with respect to the target region 78 when the connection angle of the towed vehicle 12 with respect to the tow vehicle 10 is minimum (for example, an angle at which it can be regarded as the serial state where the connection angle≈0° is satisfied). While it is possible for the tow vehicle 10 and the towed vehicle 12 to be in the serial state in all cases insofar as a long backward movement distance of the tow vehicle 10 can be ensured, there is a limit on a depth of the target region 78. Therefore, the simulation unit 70 adopts an angle which becomes a minimum deflection angle at a less than a predetermined backward movement distance as a second steering angle.

When tow support processing starts, the simulation unit 70 defines, for example, a relative coordinate system with respect to the target region 78 acquired by the target region setting unit 62 (road surface coordinate system). Based on the steering angle of the tow vehicle 10 acquired from the steering angle sensor 42, wheel speed information acquired from the vehicle wheel sensor 48, and the connection angle, the simulation unit 70 can acquire a change in a relative position of the tow vehicle 10 with respect to the target region 78 in the relative coordinate system in a case where the steering angle of the tow vehicle 10 is changed. In addition, since a relative position of the towed vehicle 12 with respect to the tow vehicle 10 can be acquired based on the connection angle, the simulation unit 70 can also acquire a change in a relative position of the towed vehicle 12 with respect to the target region 78 similarly.

The simulation unit 70 can acquire a change in the inclinations of the tow vehicle 10 and the towed vehicle 12 with respect to the target region 78 (deflection angles) in the relative coordinate system. Specifically, the simulation unit can acquire a change in the deflection angle of the tow vehicle 10 in the front-and-rear direction (direction of the vehicle central axis M: refer to FIG. 6) with respect to a direction parallel to the depth direction of the target region 78 in a case where relative positions of the tow vehicle 10 and the towed vehicle 12 have changed in the relative coordinate system. Similarly, the simulation unit 70 can acquire a change in a deflection angle of the towed vehicle 12 in the front-and-rear direction (direction of the connection central axis N: refer to FIG. 6) with respect to the direction parallel to the depth direction of the target region 78. The simulation unit 70 can acquire a third steering angle based on the relative positions and the deflection angles.

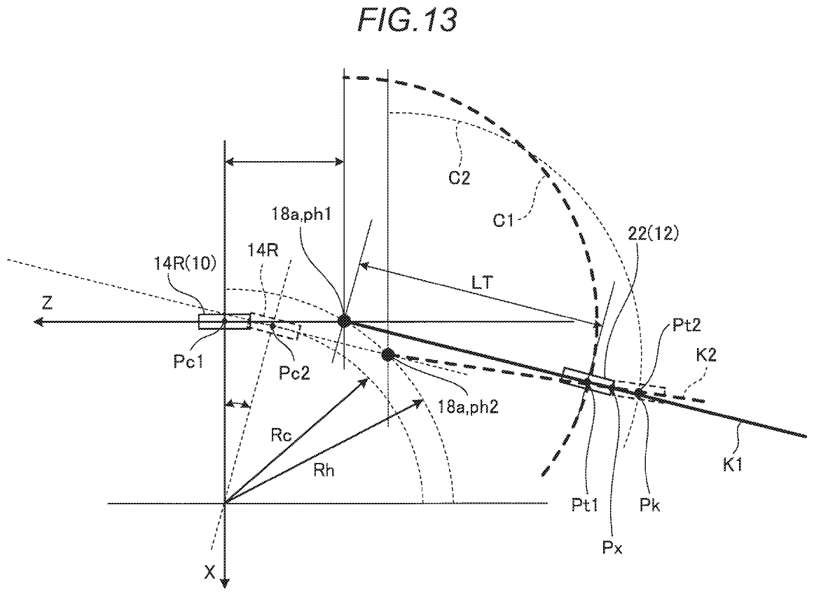

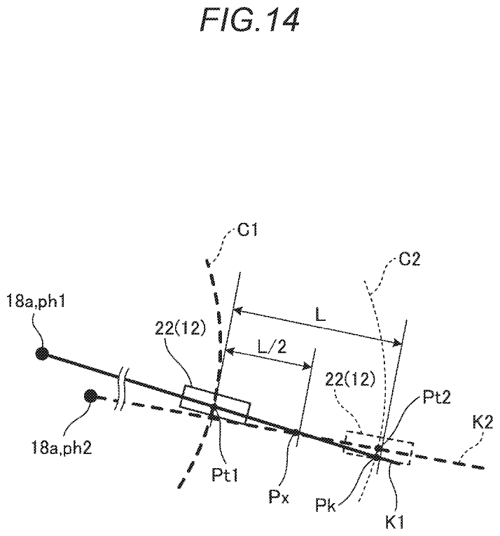

A specific example of simulation by the simulation unit 70 will be described with reference to FIG. 13 and FIG. 14, which is a partially enlarged view of FIG. 13. In order to simplify description as in FIG. 8, FIG. 13 illustrates a two-wheel shaft model in which all of the rear vehicle wheels 14R of the tow vehicle 10 and the trailer wheels 22 of the towed vehicle 12 exist in the middle in the vehicle width direction, that is, on the central axis extending in the vehicle front-and-rear direction (the rear vehicle wheels 14R are on the vehicle central axis M, and the trailer wheels 22 are on the connection central axis N). Since the hitch ball 18a that connects the tow vehicle 10 to the towed vehicle 12 is fixed to the tow vehicle 10, the position of the hitch ball 18a is known with respect to positions of the rear vehicle wheels 14R. FIG. 13 illustrates an example in which the towed vehicle 12 (trailer wheels 22) is inclined to the left with respect to the tow vehicle 10 (rear vehicle wheels 14R) at a time point when the towed vehicle 12 has moved to the target region 78 as in the scene P4 of FIG. 11.

If the steering angle of the tow vehicle 10 is changed between the balance steering angle at which the tow vehicle 10 and the towed vehicle 12 are in the balanced state and a maximum steering angle in a direction where the towed vehicle 12 is inclined in a case where the towed vehicle 12 is inclined with respect to the tow vehicle 10 as illustrated in FIG. 10, the towed vehicle 12 moves backward while inclining to a reverse direction when the tow vehicle 10 has traveled backward. For example, if the steering angle of the tow vehicle 10 is changed between the balance steering angle and a left maximum steering angle in a case where the towed vehicle 12 is inclined to the left with respect to the tow vehicle 10 as illustrated in FIG. 13, the towed vehicle 12 moves backward while inclining to the right when the tow vehicle 10 has traveled backward. That is, the connection angle changes such that the towed vehicle 12 and the tow vehicle 10 become straight (serial state). Therefore, in a case where the connection angle changes and the serial state is caused, the simulation unit 70 calculates the steering angle of the tow vehicle 10 at which a changed amount of a posture of the towed vehicle 12 with respect to the target region 78 (a changed amount of a deflection angle with respect to the direction parallel to the depth direction of the target region 78) becomes smaller in the end. The steering angle of the tow vehicle 10 at which a changed amount of the deflection angle is the minimum is acquired as a second steering angle while the tow vehicle 10 moves backward by a predetermined distance (for example, 5 m) allowed in the depth direction of the target region 78. By traveling the tow vehicle 10 backward at the second steering angle, the towed vehicle 12 and the tow vehicle 10 can be moved to the target region 78 while making the tow vehicle 10 close to the serial state with respect to the towed vehicle 12.

In FIG. 13, the steering angle of the tow vehicle 10 is changed to a virtual angle between the balance steering angle and the left maximum steering angle (virtual angle), and the tow vehicle 10 is moved backward by a predetermined short distance (for example, 0.5 m). Although a virtual steering angle sequentially changes during simulation, for example, the left maximum steering angle is set as an initial value. When the tow vehicle 10 is traveled backward, a current vehicle position Pc1 of the rear vehicle wheels 14R of the tow vehicle 10 moves on a pivoting radius Rc of the rear vehicle wheels 14R determined by the current steering angle of the tow vehicle 10, and moves to a vehicle movement position Pc2 indicated with a dashed line. At this time, since the hitch ball 18a is fixed to the tow vehicle 10, also the hitch ball 18a moves on a pivoting radius Rh of the hitch ball 18a determined by the current steering angle of the tow vehicle 10 from a current hitch position Ph1, and moves to a hitch movement position Ph2. In FIG. 13, a current trailer position Pt1 of the trailer wheels 22 (towed vehicle 12) before movement exists at a position, which is determined by the connection angle between the tow vehicle 10 and the towed vehicle 12 before movement, on a pivot circle C1 determined by the length LT of the wheel base of the towed vehicle 12, which has the current hitch position Ph1 as a center. A trailer movement position Pt2 of the trailer wheels 22 (towed vehicle 12) after movement exists at any position on a pivot circle C2 determined by the length LT of the wheel base of the towed vehicle 12, which has the hitch movement position Ph2 as a center. In this case, a pivoting (inclination) amount of the trailer movement position Pt2 associated with backward movement of the tow vehicle 10 by the predetermined short distance can be considered to be slight.

First, the simulation unit 70 sets a position where a straight line K1 that connects the current hitch position Ph1 before movement to the current trailer position Pt1 before movement intersects the pivot circle C2 of the trailer wheels 22 (towed vehicle 12) after movement as a virtual position Pk. As the hitch ball 18a moves from the current hitch position Ph1 to the hitch movement position Ph2, the trailer movement position Pt2 pivots (inclines) to the right (counterclockwise direction) around the hitch movement position Ph2 in the process of moving from a position on the pivot circle C1 to a position on the pivot circle C2. The simulation unit 70 sets a middle point L/2 between the current trailer position Pt1 and the virtual position Pk as a virtual middle point Px, and estimates that the trailer movement position Pt2 exists at a position where a straight line K2 that connects the hitch movement position Ph2 after movement to the virtual middle point Px intersects the pivot circle C2 of the trailer wheels 22 (towed vehicle 12) after movement. The same also applies to a case where the tow vehicle 10 is inclined to the right with respect to the towed vehicle 12, and simulation may be performed by setting a virtual angle to an angle between the balance steering angle and a right maximum steering angle.

The simulation unit 70 newly sets the vehicle movement position Pc2, the hitch movement position Ph2, and the estimated trailer movement position Pt2 as positions before movement. Then, the simulation unit 70 repeatedly executes the next movement position estimation processing in a case where backward movement by the predetermined short distance (for example, 0.5 m) is performed as described above onto the new positions before movement. The simulation unit 70 repeats the estimation processing, for example, until the connection angle of the towed vehicle 12 with respect to the tow vehicle 10 becomes an angle that is close to the connection angle=0° (the serial state is caused), and calculates a changed amount of the deflection angle of the towed vehicle 12 with respect to the target region 78 of that time. Then, the simulation unit 70 sets an angle at which the backward movement distance of the tow vehicle 10 for bringing the tow vehicle 10 into the serial state with respect to the towed vehicle 12 is less than a predetermined limit value (for example, 5 m) as a candidate of the second steering angle, and temporarily saves the changed amount of the deflection angle of the towed vehicle 12 and the virtual steering angle of that time in the RAM 36c.

The simulation unit 70 repeatedly executes simulation of calculating the “changed amount” of the deflection angle described above, for example, until reaching the balance steering angle between the tow vehicle 10 and the towed vehicle 12 at the time of the scene P4 of FIG. 11 while increasing the virtual steering angle by a predetermined angle (for example, 10°). The simulation unit 70 sets a virtual steering angle corresponding to a deflection angle minimum value, at which the changed amount of the deflection angle is minimum, as a second steering angle. The second steering angle outputting unit 68c of the outputting unit 68 outputs the second steering angle to the automatic traveling control portion 72 or the guided traveling instruction unit 74, and executes tow support subsequent to the scene P4 of FIG. 11. A mode in which the second steering angle outputting unit 68c outputs the second steering angle is referred to as a “serial mode” in some cases.

In a case where the towed vehicle 12 is inclined with respect to the target region 78 and moves at the stage of the scene P4, for example, the deflection angle of the towed vehicle 12 with respect to the direction parallel to the depth direction of the target region 78 is inclined by an allowable value (for example, ±5°) or more in some cases. In this case, the simulation unit 70 may bring the tow vehicle 10 into the serial state with respect to the towed vehicle 12, and calculate a simulation result of a third steering angle at which posture correction is performed such that the towed vehicle 12 becomes close to being parallel to the depth direction of the target region 78 (third steering angle).

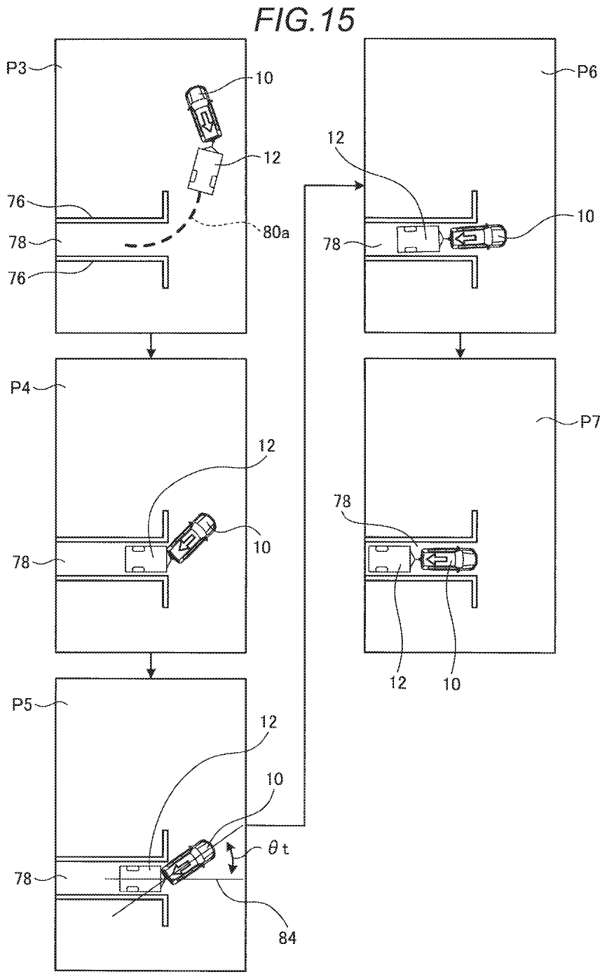

FIG. 15 is an exemplary schematic view illustrating a situation where the towed vehicle 12 and the tow vehicle 10 move to the target region 78 while the tow vehicle 10 to which the towed vehicle 12 is connected travels backward with the use of the simulation result of the simulation unit 70. FIG. 15 also illustrates the scene P3 and the scene P4 of FIG. 11.

In the scene P3 illustrated in FIG. 15, the tow support unit 52 is executing the “connection angle maintaining mode”, and the tow vehicle 10 travels backward toward the target region 78 at the first steering angle in order to move the towed vehicle 12 in accordance with the recommended moving course 80a. In the scene P4, the towed vehicle 12 has completed, for example, movement at the deflection angle of “0°” with respect to the direction parallel to the depth direction of the target region 78 (for example, a center line 84 of the target region 78). At this time, as illustrated in a scene P5, the tow vehicle 10 which has moved backward in a state where the connection angle is maintained at the first steering angle (for example, the balance steering angle) is inclined to the left by an angle θt with respect to the towed vehicle 12. In this case, the tow support unit 52 can move to the “serial mode”. The simulation unit 70 executes simulation of calculating the second steering angle at which the deflection angle of the tow vehicle 10 is made close to the deflection angle (0°) of the towed vehicle 12 (second steering angle) while traveling the tow vehicle 10 backward after maintaining the deflection angle of the towed vehicle 12 with respect to the target region 78 (0° in the case of the scene P5) such that the tow vehicle 10 and the towed vehicle 12 are in the serial state.

The scene P5 illustrates a situation where the towed vehicle 12 suppresses a change in the deflection angle with respect to the target region 78 to be minimum and the deflection angle of the tow vehicle 10 becomes closer to the deflection angle of the towed vehicle 12 (situation where the angle θt decreases), in traveling at the second steering angle based on the simulation result of the simulation unit 70. A scene P6 illustrates a state where the deflection angle of the tow vehicle 10 is closest to the deflection angle of the towed vehicle 12 (serial state). In a case where this state is caused, it is sufficient for the tow vehicle 10 to simply travel backward with the steering angle at a neutral position (steering angle=0°). However, also in this case, it is necessary to return to the steering angle=0° from the state of the second steering angle and to travel backward with this state maintained. The balance steering angle calculation unit 60 calculates a third steering angle of the tow vehicle 10 for maintaining the serial state between the towed vehicle 12 and the tow vehicle 10, that is, maintaining the connection angle. Then, the third steering angle outputting unit 68d outputs the third steering angle calculated by the balance steering angle calculation unit 60 to the automatic traveling control portion 72 or the guided traveling instruction unit 74, and causes the towed vehicle 12 and the tow vehicle 10 to travel backward. As a result, as illustrated in a scene P7, the towed vehicle 12 and the tow vehicle 10 can completely move to the target region 78 with the serial state maintained.

In a case where the tow support system 100 realizes tow support through automatic traveling control, the automatic traveling control portion 72 receives a steering angle according to each situation (the first steering angle, the correction steering angle, the second steering angle, and the third steering angle), which is provided from the outputting unit 68, to control the steering system 34 with the use of PID control, and controls the steering angle of the tow vehicle 10. In addition, the automatic traveling control portion 72 controls the brake system 38 and the drive system 40, and travels the tow vehicle 10 backward in a direction along each steering angle at a safe vehicle speed, for example, 5 km/h or lower. In addition, in a case where the tow support system 100 realizes tow support through a guided traveling instruction, the tow support system gives an instruction of a steering angle according to each situation from the outputting unit 68 to a driver. The guided traveling instruction unit 74 causes, via the display control section 36d, the display device 26 to display, for example, each steering angle, a steering direction, an accelerator operation amount, a brake operation amount, and operation timings thereof. The tow support system suggests driving operation to the driver in accordance with the display content. In this case, the guided traveling instruction unit 74 may provide an operation instruction in the form of a voice message from the voice output device 28 via the voice control portion 36e. In a case where the guided traveling instruction unit 74 gives an instruction of changing a steering angle, the guided traveling instruction unit 74 may give a stop instruction of temporarily stopping the tow vehicle 10 prior to changing the steering angle. By stopping the tow vehicle 10 before changing the steering angle, it becomes possible to reduce a delay on a steering timing and an error in steering, and thus appropriate steering for moving the towed vehicle 12 and the tow vehicle 10 to the target region 78 can be realized. In another embodiment, the tow support system 100 may execute tow support by causing the automatic traveling control portion 72 and the guided traveling instruction unit 74 to cooperate with each other. For example, only steering may be executed through automatic control by the automatic traveling control portion 72, and other operation, for example, accelerator operation and brake operation may be executed by the driver in accordance with an operation instruction provided by the guided traveling instruction unit 74. Content of operation executed by the automatic traveling control portion 72 and the guided traveling instruction unit 74 may be determined in initial setting, or may be changed as appropriate according to operation by the driver or a dealer-operator. In this case, a processing load of the tow support system 100 can be reduced. It is possible to involve in driving operation by the driver at the time of backward movement for towing, and to contribute to improving a driving skill of the driver as well.

As described above, under the tow support system 100, in a case where the towed vehicle 12 is traveled backward, the towed vehicle 12 or the tow vehicle 10 and the towed vehicle 12 can be moved to the target region (position) smoothly and in a state where a burden to a driver is reduced.

The CPU 36a can generate an overhead image based on the captured image data obtained by each of the imaging units 24. Therefore, in a case where tow support processing starts, the tow support unit 52 generates an overhead image and may cause the display device 26 to display a situation where the tow vehicle 10 and the towed vehicle 12 move as illustrated in FIGS. 11 and 15. In this case, a vehicle icon corresponding to the tow vehicle 10 and a trailer icon corresponding to the towed vehicle 12 are superimposed onto the overhead image, and the superimposed image is displayed.

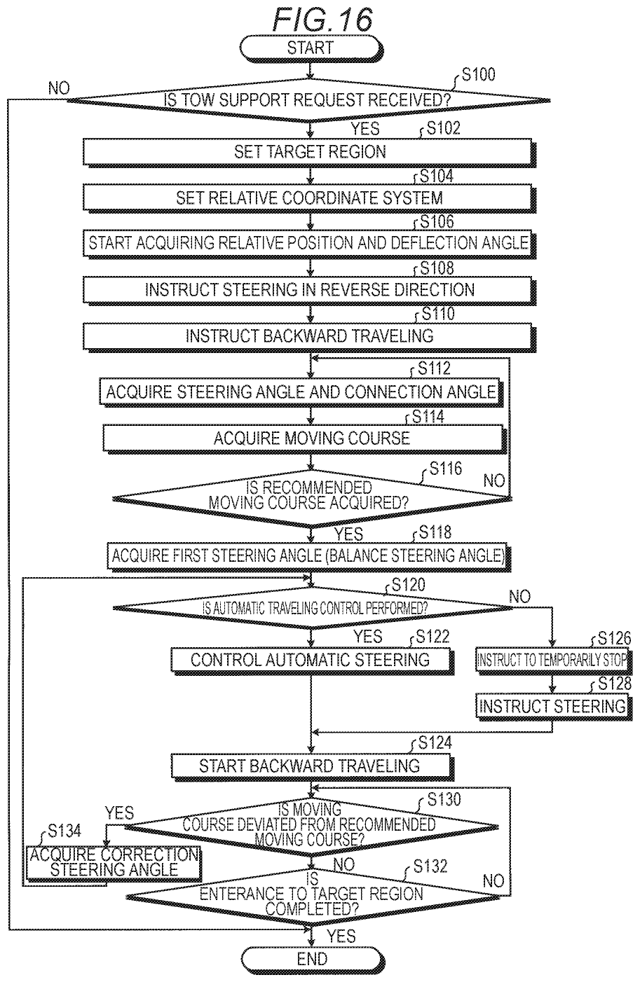

An example of processing by the tow support system 100 configured as described above in a case where the towed vehicle 12 and the tow vehicle 10 are moved to the target region 78 will be described based on flow charts of FIGS. 16 to 18.

When the tow vehicle 10 is in a state of being capable of traveling, the tow support unit 52 performs monitoring at all times on whether or not a tow support request is received (S100). In a case where the tow support request is not received (No of S100), the tow support unit 52 temporarily ends this flow. The tow support request can be received, for example, by input operation performed by a driver via the operation input unit 30. In a case where the tow support system 100 has received the tow support request (Yes of S100), the target region setting unit 62 sets the target region 78 (S102). For example, the target region 78 to which the towed vehicle 12 or the towed vehicle 12 and the tow vehicle 10 can be moved is set from a captured image showing the surrounding situation of the tow vehicle 10 and the towed vehicle 12, which is captured by the imaging units 24. Then, the simulation unit 70 sets, for example, a relative coordinate system having the set target region 78 as the origin (road surface coordinate system) (S104), and starts acquiring the relative positions of the tow vehicle 10 and the towed vehicle 12 with respect to the target region 78 and the deflection angles of the tow vehicle 10 and the towed vehicle 12 with respect to the direction parallel to the depth direction of the target region 78 (center line 84) (S106).

Next, the tow support system 100 gives an instruction of perform steering, at a position separated away from the set target region 78 by a predetermined distance, in a reverse direction to a direction where the target region 78 exists with the tow vehicle 10 as reference to a driver via the display device 26 or the voice output device 28 (S108). The position separated away by a predetermined distance is a position separated away from the target region 78 by a distance that is sufficient to allow the towed vehicle 12 to pivot at the time of backward traveling. Next, the tow support system 100 gives an instruction of traveling backward at a predetermined speed (for example, 5 km/h) or lower to the driver via the display device 26 or the voice output device 28 (S110).

When the tow vehicle 10 starts backward traveling, the steering angle acquisition unit 56 starts acquiring the current steering angle of the tow vehicle 10 and the connection angle between the tow vehicle 10 and the towed vehicle 12 (S112). In addition, the course acquisition unit 64 starts acquiring the moving course 80 with respect to the target region 78 associated with backward traveling of the towed vehicle 12 (S114). The comparison unit 66 monitors, for example, whether or not the recommended moving course 80a passing through the predetermined area in the opening direction, with respect to the middle position We of the opening W of the target region 78, is acquired (S116). In a case where the recommended moving course 80a is not acquired, processing returns to S112 and monitoring is again performed. In a case where the recommended moving course 80a is acquired (Yes of S116), it is a timing when the towed vehicle 12 is moved to the target region 78 in a state where the connection angle between the tow vehicle 10 and the towed vehicle 12 is maintained (“connection angle maintaining mode” execution timing). Therefore, the balance steering angle calculation unit 60 calculates the steering angle of the tow vehicle 10 at which the current connection angle is maintained, for example, the balance steering angle, as a first steering angle (S118). In a case where automatic traveling control is designated as means for realizing tow support received in S100 (Yes of S120), the first steering angle outputting unit 68a outputs the first steering angle (balance steering angle) to the automatic traveling control portion 72 (S122). The automatic traveling control portion 72, for example, performs PID control onto the steering system 34 to realize the first steering angle, and controls the brake system 38 and the drive system 40 to start backward traveling of the tow vehicle 10 (towed vehicle 12) (S124). On the other hand, in a case where it is determined that automatic traveling control is not designated in S120 (No of S120), that is, in a case where tow support is executed through driving by a driver, the guided traveling instruction unit 74 first instructs to temporarily stop the tow vehicle 10 (S126). In a case where it is checked that the tow vehicle 10 has temporarily stopped based on a detection signal from the vehicle wheel sensor 48, the guided traveling instruction unit 74 gives an instruction of steering at the first steering angle, with the use of the display device 26 or the voice output device 28 (S128). For example, the driver is provided with a steering direction and a steering amount. In this case, for example, in a case where an icon of the steering wheel is displayed on the display device 26, the steering direction is indicated with an arrow on the display device, and the steering amount corresponds to the first steering angle, the guided traveling instruction unit 74 may change a display form of the icon, and may notify the driver of completion of a change to the first steering angle. Next, the guided traveling instruction unit 74 notifies the driver of an accelerator operation amount, a brake operation amount, and operation timings thereof with the use of the display device 26 or the voice output device 28, and starts backward traveling (S124).

During automatic traveling control by the automatic traveling control portion 72, or during guided traveling instruction by the guided traveling instruction unit 74, the comparison unit 66 monitors whether or not the actual course 80b, which is an actual moving course of the towed vehicle 12, deviates from the recommended moving course 80a (S130). Since the tow support unit 52 monitors the relative position of the towed vehicle 12 with respect to the target region 78 at all times, the towed vehicle 12 does not deviate from the recommended moving course 80a (No of S130). In a case where it can be checked that entrance to the target region 78 is completed as illustrated in the scene P4 of FIG. 11 (Yes of S132), this flow ends. In a case where it is determined that entrance to the target region 78 is not completed in S132 (No of S132), the tow support unit 52 returns to S130, and the comparison unit 66 continues monitoring the occurrence or non-occurrence of deviation from the recommended moving course 80a.

On the other hand, in a case where the comparison unit 66 detects that the actual course 80b has deviated from the recommended moving course 80a by a predetermined amount (predetermined distance) or more in S130 (Yes of S130), the balance steering angle calculation unit 60 calculates a correction steering angle for correcting the deviation (S134). The tow support unit 52 returns to processing of S120. The correction steering angle outputting unit 68b outputs the correction steering angle to the automatic traveling control portion 72 or the guided traveling instruction unit 74, and execute processing subsequent to S120.

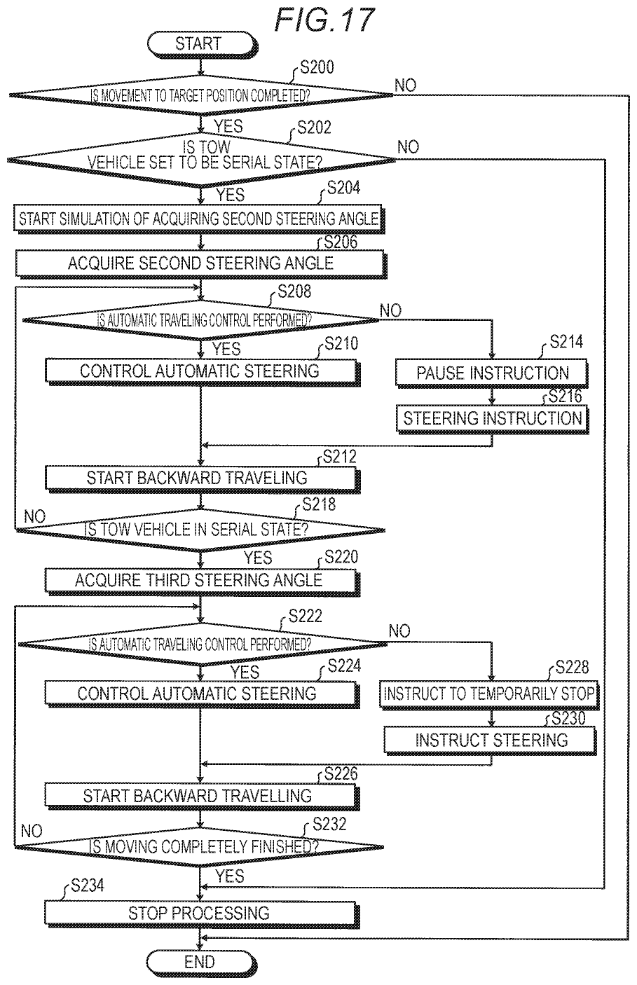

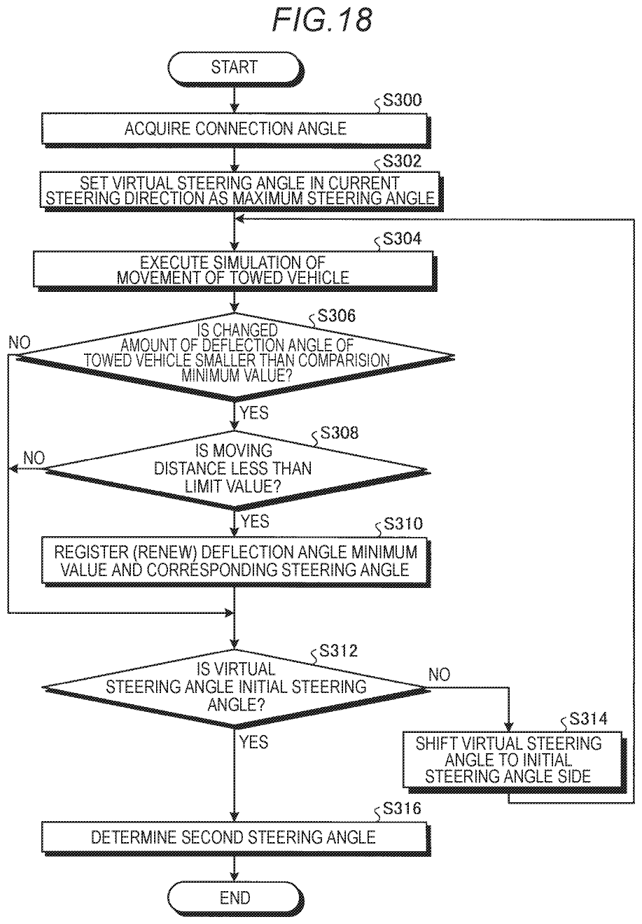

When it can be checked that the towed vehicle 12 has completed movement to the target region 78, the tow support unit 52 starts processing shown in FIG. 17 (Yes of S200). In a case where the tow support unit 52 determines that an instruction of bringing the tow vehicle 10 into the serial state with respect to the towed vehicle 12 when moved to the target region 78 is included in the tow support request received in S100 (Yes of S202), the simulation unit 70 starts simulation of acquiring a second steering angle in accordance with the flow chart shown in FIG. 18 (S204).

The simulation unit 70 acquires the connection angle between the towed vehicle 12 and the tow vehicle 10 when the towed vehicle 12 has completed movement to the target region 78 from the connection angle acquisition unit 54 (S300). Next, a virtual steering angle in a case of executing simulation is determined based on the current steering angle of the tow vehicle 10, which is acquired from the steering angle sensor 42. In this case, the simulation unit 70 detects a steering direction based on a detection result of the steering angle sensor 42, and sets a maximum steering angle in the current steering direction as a maximum steering angle of an initial stage of simulation (S302). Then, the simulation unit 70 executes simulation of movement of the towed vehicle 12 as illustrated in FIGS. 13 and 14 (S304). That is, simulation of calculating a changed amount of the posture (deflection angle) of the towed vehicle 12 with respect to the target region 78 is executed at the time of the virtual steering angle (the maximum steering angle at the initial stage). The simulation unit 70 compares the changed amount of the deflection angle calculated through the simulation with a comparison minimum value (S306). For example, in a case where the virtual steering angle is the maximum steering angle, the comparison minimum value is set to a large value (for example, 60°) as an initial value. In a case where the virtual angle is the maximum steering angle, the determination of S306 is mostly positive determination (Yes of S306). That is, the deflection angle of the towed vehicle 12 in a case where the tow vehicle 10 is traveled backward at the maximum steering angle is set as comparison reference (comparison minimum value) when executing subsequent simulation.

Next, whether or not a moving distance necessary to bring the tow vehicle 10 into the serial state with respect to the towed vehicle 12 in the simulation executed in S304 is less than a limit value is checked (S308). In a case of bringing the tow vehicle 10 into the serial state with respect to the towed vehicle 12, it is necessary to realize the serial state with less than a limit distance (limit value) allowable in the depth direction of the target region 78. Therefore, in a case where the moving distance for causing the serial state is less than the limit value (Yes of S308), the simulation unit 70 registers (renews) the deflection angle minimum value and a steering angle corresponding thereto in the RAM 36c (S310). The deflection angle first value of that time is adopted as a comparison minimum value when executing the processing of S306 in the next processing cycle.

In a case where the virtual angle used in the current simulation is not an initial steering angle (for example, a balance steering angle at the time of simulation start) (No of S312), the simulation unit 70 shifts the virtual steering angle to an initial steering angle side (S314). That is, the virtual steering angle is set to a steering angle to which, for example 10°, is added. Then, processing transitions to S304 to execute the simulation of movement of the towed vehicle 12, and processing subsequent to S304 is repeated.

In a case where the virtual angle used in the current simulation is equal to the initial steering angle or a practically initial steering angle in S312 (Yes of S312), a steering angle corresponding to the deflection angle minimum value registered in the RAM 36c is determined as a second steering angle (S316), and this flow temporarily ends. In a case where a moving distance necessary for causing the serial state is equal to or larger than the limit value in S308 (No of S308), the simulation unit 70 determines that the serial state cannot be realized in a depth space of the target region 78, and skips processing of S310. Similarly, in a case where the changed amount of the deflection angle of the towed vehicle 12 is equal to or larger than a comparison first value in S306 (No of S306), the simulation unit skips processing of S308 and S310.

Referring back to the flow chart of FIG. 17, in a case where the second steering angle outputting unit 68c has acquired the second steering angle (S206), and in a case where the tow support unit 52 has designated automatic traveling control (Yes of S208), the second steering angle outputting unit 68c outputs the second steering angle to the automatic traveling control portion 72 (S210). The automatic traveling control portion 72, for example, performs PID control onto the steering system 34 to realize the second steering angle, and controls the brake system 38 and the drive system 40 to start backward traveling of the tow vehicle 10 (towed vehicle 12) (S212). On the other hand, in a case where it is determined that automatic traveling control is not designated in S208 (No of S208), that is, in a case where operation of causing the serial state is executed through driving by the driver, the guided traveling instruction unit 74 instructs to temporarily stop the tow vehicle 10 (S214). In a case where it is checked that the tow vehicle 10 has temporarily stopped based on a detection signal from the vehicle wheel sensor 48, the guided traveling instruction unit 74 gives an instruction of steering at the second steering angle with the use of the display device 26 or the voice output device 28 (S216). For example, the driver is provided with a steering direction and a steering amount. In this case, for example, in a case where an icon of the steering wheel is displayed on the display device 26, the steering direction is indicated with an arrow on the display device, and the steering amount corresponds to the second steering angle, the guided traveling instruction unit 74 may change a display form of the icon, and may notify the driver of completion of a change to the second steering angle. Next, the guided traveling instruction unit 74 notifies the driver of an accelerator operation amount, a brake operation amount, and operation timings thereof with the use of the display device 26 or the voice output device 28, and starts backward traveling (S212).

In a case where it is determined that the tow vehicle 10 is in the serial state with respect to the towed vehicle 12 based on an acquisition result of the connection angle acquisition unit 54 (Yes of S218), the tow support unit 52 travels the tow vehicle 10 and the towed vehicle 12 backward with the serial state maintained, and causes the balance steering angle calculation unit 60 to calculate the third steering angle for moving to the target region 78. The second steering angle for causing the serial state is the imbalance steering angle for pivoting the tow vehicle 10 with respect to the towed vehicle 12. Therefore, in a case where the tow vehicle 10 continues backward traveling in that state, the serial state is not maintained. The tow support unit 52 causes the balance steering angle calculation unit 60 to calculate the balance steering angle (for example, the steering angle=0) at which the serial state is maintained.

In a case where the third steering angle outputting unit 68d has acquired the third steering angle (S220), and in a case where the tow support unit 52 has designated automatic traveling control (Yes of S222), the third steering angle outputting unit 68d outputs the third steering angle to the automatic traveling control portion 72 (S224). The automatic traveling control portion 72, for example, performs PID control onto the steering system 34 to realize the third steering angle, and controls the brake system 38 and the drive system 40 to start backward traveling of the tow vehicle 10 (towed vehicle 12) (S226). On the other hand, in a case where it is determined that automatic traveling control is not designated in S222 (No of S222), that is, in a case where operation of causing the serial state is executed through driving by the driver, the guided traveling instruction unit 74 instructs to temporarily stop the tow vehicle 10 (S228). In a case where it is checked that the tow vehicle 10 has temporarily stopped based on a detection signal from the vehicle wheel sensor 48, the guided traveling instruction unit 74 gives an instruction of steering at the third steering angle, with the use of the display device 26 or the voice output device 28 (S230). For example, the driver is provided with a steering direction and a steering amount. In this case, for example, in a case where an icon of the steering wheel is displayed on the display device 26, the steering direction is indicated with an arrow on the display device, and the steering amount corresponds to the third steering angle, the guided traveling instruction unit 74 may change a display form of the icon, and may notify the driver of completion of a change to the third steering angle. Next, the guided traveling instruction unit 74 notifies the driver of an accelerator operation amount, a brake operation amount, and operation timings thereof, with the use of the display device 26 or the voice output device 28, and starts backward traveling (S226).

In a case where it is determined that the tow vehicle 10 and the towed vehicle 12 have completely finished moving to predetermined positions in the target region 78 with reference to the current relative positions of the tow vehicle 10 and the towed vehicle 12 with respect to the target region 78 (S232), the tow support unit 52 executes processing of stopping the tow vehicle 10 (S234), and a series of various types of tow support processing end. That is, in a case where the automatic traveling control portion 72 executes automatic traveling control, the tow support unit 52 causes the automatic traveling control portion 72 to control the drive system 40 and the brake system 38, thereby stopping the tow vehicle 10. In addition, in a case where the guided traveling instruction unit 74 gives a guided traveling instruction, the tow support unit 52 causes the guided traveling instruction unit 74 to output a stop instruction via the display device 26 or the voice output device 28, thereby causing the driver to stop the tow vehicle 10.

In a case where the tow support unit 52 determines that movement is not completely finished in S232 (No of S232), processing transitions to S222, and processing subsequent to S222 is executed. In addition, in a case where the tow support unit 52 determines that the tow vehicle 10 is not yet to be in the serial state with respect to the towed vehicle 12 in S218 (No of S218), processing transitions to S208, and processing subsequent to S208 is executed.

In a case where the tow support unit 52 determines that an instruction of bringing the tow vehicle 10 into the serial state is not included in the tow support request received in S100 in S202 (No of S202), processing transitions to S234, and processing of stopping the tow vehicle 10 is executed. That is, in the state of the scene P4 of FIG. 11, the tow vehicle 10 is stopped. In this case, for example, connection between the towed vehicle 12 and the tow vehicle 10 is released, and thus it is possible to move the tow vehicle 10 to another position. In a case where the towed vehicle 12 determines that movement of the towed vehicle 12 to the target region 78 is not completed in S200 (No of S200), this flow is not executed.

In the tow support system 100 of the embodiment as described above, in a case where the tow vehicle 10 to which the towed vehicle 12 is connected is traveled backward to move the towed vehicle 12 to the target region 78, an optimal steering angle and a change in the steering angle are output at an appropriate timing. As a result, the towed vehicle 12 can be smoothly moved to the target region 78 while reducing a load on a driver. Similarly, in a case where the tow vehicle 10 is intended to be moved to the target region 78 in the serial state along with the towed vehicle 12, an optimal steering angle and a change in the steering angle are output at an appropriate timing. As a result, the tow vehicle 10 can be smoothly moved to the target region 78 with the tow vehicle in the serial state with respect to the towed vehicle 12 while reducing a load on the driver. That is, regardless of skill of the driver, the towed vehicle 12 or the towed vehicle 12 and the tow vehicle 10 can be smoothly and easily traveled backward to the target region 78.

Although an example in which the towed vehicle 12 or the tow vehicle 10 to which the towed vehicle 12 is connected is moved to the target region 78 such as a parking space is described in the embodiment described above, the present disclosure is not limited thereto. For example, a case where the towed vehicle 12 or the tow vehicle 10 to which the towed vehicle 12 is connected is simply moved backward to a certain position is also applicable. Insofar as a destination for movement can be set by the target region setting unit 62, the towed vehicle or the tow vehicle is movable through the same processing, and the same effect can be obtained.

In addition, although an example in which the target region 78 is set as reference in a case of setting the relative coordinate system (road surface coordinate system) is given in the description made above, a position of the tow vehicle 10 when starting tow support may be set as reference in another embodiment, and the same effect can be obtained through the same processing.

A tow support program of the embodiment which is executed by the CPU 36a may be configured to be provided by being recorded in a computer readable recording medium, such as a CD-ROM, a flexible disk (FD), a CD-R, and a digital versatile disk (DVD), as a file in an installable format or an executable format.

The tow support program may be configured to be provided by being stored in a computer connected to a network, such as the Internet, and being downloaded via the network. In addition, the tow support program executed in the embodiment may be configured to be provided or distributed via a network such as the Internet.

Although the embodiment and a modification example disclosed here are described, the embodiment and the modification example are provided as examples, and do not limit the scope of this disclosure. The new embodiment can be executed in a variety of other forms, and various types of omission, substitution and change can be made without departing from the spirit of this disclosure. The embodiment and a modification thereto are included in the scope and spirit of this disclosure, and are included in the scope of the appended claims and a scope equivalent thereto.

In the tow support device according to the embodiment, automatic traveling of the tow vehicle may be executed based on the first steering angle such that the towed vehicle is accommodated in the target region. In the configuration, for example, the towed vehicle can be smoothly, easily, and reliably moved to the target region.

In the tow support device according to the embodiment, a guided traveling instruction for traveling the tow vehicle backward through manual driving based on the first steering angle may be given such that the towed vehicle is accommodated in the target region. In the configuration, for example, the towed vehicle can be smoothly and easily moved to the target region by a driver performing driving operation in accordance with instruction content of the tow support device.

In the tow support device according to the embodiment, in a case where the tow vehicle travels backward based on the first steering angle, and in a case where an actual course and the recommended moving course of the towed vehicle are separated away from each other by a predetermined value or more, the output unit may output a correction steering angle for bringing the actual course back to the recommended moving course. In the configuration, for example, even in a case where the actual course of the towed vehicle or the tow vehicle is shifted away from the recommended moving course due to a road surface state and other external factors, the towed vehicle can be rapidly brought back to the recommended moving course through traveling correction based on a correction steering angle.

In the tow support device according to the embodiment, the output unit may output a steering angle of the tow vehicle for changing the connection angle from start of backward traveling of the tow vehicle such that the towed vehicle is inclined to a direction where the target region exists, and may output the first steering angle in a case where the moving course of the towed vehicle based on a change in the connection angle coincides with the recommended moving course. In the configuration, for example, an appropriate steering angle at which the towed vehicle faces (sees) the target region is output, and then, in a case where the moving course of the towed vehicle has become the recommended moving course, the first steering angle is output. As a result, a series of moving operations of the tow vehicle and the towed vehicle can be smoothly and efficiently realized until the towed vehicle reaches the target region from the start of backward traveling of the tow vehicle.

The tow support device according to the embodiment may further include a simulation unit that simulates, based on a steering angle of the tow vehicle and the connection angle, a change in relative positions of the tow vehicle and the towed vehicle with respect to the target region in a case where the steering angle is changed and a change in a deflection angle of the tow vehicle in a front-and-rear direction with respect to a direction parallel to a depth direction of the target region and a deflection angle of the towed vehicle in a front-and-rear direction with respect to the direction parallel to the depth direction of the target region, and in a case where the towed vehicle is accommodated in the target region, and in a case where the tow vehicle is traveled backward with the deflection angle of the towed vehicle with respect to the target region maintained, the output unit may output a second steering angle of the tow vehicle at which the deflection angle of the tow vehicle is made close to the deflection angle of the towed vehicle. In the configuration, for example, in a case where the tow vehicle is intended to be moved to the target region in a state (serial state) where the tow vehicle is connected to the towed vehicle straight, the second steering angle at which a change (deflection) in a posture of the towed vehicle with respect to the target region is minimum is output. As a result, regardless of skill of a driver, the tow vehicle can be smoothly and easily traveled and moved to the target region through backward traveling in a posture where the towed vehicle and the tow vehicle are connected to each other in the serial state.

In the tow support device according to the embodiment, automatic traveling may be executed at the time of backward movement of the tow vehicle based on the second steering angle. In the configuration, for example, the towed vehicle and the tow vehicle can be smoothly and easily moved through backward traveling such that the connection state between the towed vehicle and the tow vehicle is in the serial state in the process of backward traveling to the target region.

In the tow support device according to the embodiment, a guided traveling instruction for traveling the tow vehicle backward through manual driving based on the second steering angle may be given. In the configuration, for example, the towed vehicle and the tow vehicle can be smoothly and easily moved through backward traveling such that the connection state between the towed vehicle and the tow vehicle is in the serial state in the process of backward traveling to the target region by a driver performing driving operation in accordance with instruction content of the tow support device.

In the tow support device according to the embodiment, the output unit may output a third steering angle of the tow vehicle for maintaining the connection angle in a state where the deflection angle of the tow vehicle is closest to the deflection angle of the towed vehicle. In the configuration, for example, it is possible to move the towed vehicle and the tow vehicle into the target region with the serial state maintained, and thus all of the tow vehicle and the towed vehicle can be accommodated in the target region.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A tow support device comprising:
an acquisition unit that acquires a connection angle between a tow vehicle and a towed vehicle;
a setting unit that sets a target region to which at least the towed vehicle is movable;
a course acquisition unit that acquires transition of a moving course of the towed vehicle based on a change in the connection angle in a case where the tow vehicle travels backward; and
an output unit that outputs a first steering angle of the tow vehicle for maintaining the connection angle in a case where the moving course that transitions to correspond to backward traveling of the tow vehicle is a recommended moving course on which the towed vehicle is movable to the target region.

2. The tow support device according to claim 1,
wherein automatic traveling of the tow vehicle is executed based on the first steering angle such that the towed vehicle is accommodated in the target region.

3. The tow support device according to claim 1,
wherein a guided traveling instruction for traveling the tow vehicle backward through manual driving based on the first steering angle is given such that the towed vehicle is accommodated in the target region.

4. The tow support device according to claim 1,
wherein in a case where the tow vehicle travels backward based on the first steering angle, and in a case where an actual course and the recommended moving course of the towed vehicle are separated away from each other by a predetermined value or more, the output unit outputs a correction steering angle for bringing the actual course back to the recommended moving course.

5. The tow support device according to claim 1,
wherein the output unit outputs a steering angle of the tow vehicle for changing the connection angle from start of backward traveling of the tow vehicle such that the towed vehicle is inclined to a direction where the target region exists, and outputs the first steering angle in a case where the moving course of the towed vehicle based on a change in the connection angle coincides with the recommended moving course.

6. The tow support device according to claim 1, further comprising:
a simulation unit that simulates, based on a steering angle of the tow vehicle and the connection angle, a change in relative positions of the tow vehicle and the towed vehicle with respect to the target region in a case where the steering angle is changed and a change in a deflection angle of the tow vehicle in a front-and-rear direction with respect to a direction parallel to a depth direction of the target region and a deflection angle of the towed vehicle in a front-and-rear direction with respect to the direction parallel to the depth direction of the target region,
wherein in a case where the towed vehicle is accommodated in the target region, and in a case where the tow vehicle is traveled backward with the deflection angle of the towed vehicle with respect to the target region maintained, the output unit outputs a second steering angle of the tow vehicle at which the deflection angle of the tow vehicle is made close to the deflection angle of the towed vehicle.

7. The tow support device according to claim 6,
wherein automatic traveling is executed at the time of backward movement of the tow vehicle based on the second steering angle.

8. The tow support device according to claim 6,
wherein a guided traveling instruction for traveling the tow vehicle backward through manual driving based on the second steering angle is given.

9. The tow support device according to claim 6,
wherein the output unit outputs a third steering angle of the tow vehicle for maintaining the connection angle in a state where the deflection angle of the tow vehicle is closest to the deflection angle of the towed vehicle.

10. The tow support device according to claim 2,
wherein a guided traveling instruction for traveling the tow vehicle backward through manual driving based on the first steering angle is given such that the towed vehicle is accommodated in the target region.

11. The tow support device according to claim 2,
wherein in a case where the tow vehicle travels backward based on the first steering angle, and in a case where an actual course and the recommended moving course of the towed vehicle are separated away from each other by a predetermined value or more, the output unit outputs a correction steering angle for bringing the actual course back to the recommended moving course.

12. The tow support device according to claim 3,
wherein in a case where the tow vehicle travels backward based on the first steering angle, and in a case where an actual course and the recommended moving course of the towed vehicle are separated away from each other by a predetermined value or more, the output unit outputs a correction steering angle for bringing the actual course back to the recommended moving course.

13. The tow support device according to claim 2,
wherein the output unit outputs a steering angle of the tow vehicle for changing the connection angle from start of backward traveling of the tow vehicle such that the towed vehicle is inclined to a direction where the target region exists, and outputs the first steering angle in a case where the moving course of the towed vehicle based on a change in the connection angle coincides with the recommended moving course.

14. The tow support device according to claim 3,
wherein the output unit outputs a steering angle of the tow vehicle for changing the connection angle from start of backward traveling of the tow vehicle such that the towed vehicle is inclined to a direction where the target region exists, and outputs the first steering angle in a case where the moving course of the towed vehicle based on a change in the connection angle coincides with the recommended moving course.

15. The tow support device according to claim 2, further comprising:
a simulation unit that simulates, based on a steering angle of the tow vehicle and the connection angle, a change in relative positions of the tow vehicle and the towed vehicle with respect to the target region in a case where the steering angle is changed and a change in a deflection angle of the tow vehicle in a front-and-rear direction with respect to a direction parallel to a depth direction of the target region and a deflection angle of the towed vehicle in a front-and-rear direction with respect to the direction parallel to the depth direction of the target region,
wherein in a case where the towed vehicle is accommodated in the target region, and in a case where the tow vehicle is traveled backward with the deflection angle of the towed vehicle with respect to the target region maintained, the output unit outputs a second steering angle of the tow vehicle at which the deflection angle of the tow vehicle is made close to the deflection angle of the towed vehicle.

16. The tow support device according to claim 3, further comprising:
a simulation unit that simulates, based on a steering angle of the tow vehicle and the connection angle, a change in relative positions of the tow vehicle and the towed vehicle with respect to the target region in a case where the steering angle is changed and a change in a deflection angle of the tow vehicle in a front-and-rear direction with respect to a direction parallel to a depth direction of the target region and a deflection angle of the towed vehicle in a front-and-rear direction with respect to the direction parallel to the depth direction of the target region,
wherein in a case where the towed vehicle is accommodated in the target region, and in a case where the tow vehicle is traveled backward with the deflection angle of the towed vehicle with respect to the target region maintained, the output unit outputs a second steering angle of the tow vehicle at which the deflection angle of the tow vehicle is made close to the deflection angle of the towed vehicle.
